(19) United States
(12) Patent Application Publication
(10) Pub. No.: US 2023/0314751 A1
(43) Pub. Date: Oct. 5, 2023

(54) OPTICAL FIBER SHEATH HOLDERS FOR FIBER OPTIC CLOSURE ORGANIZERS

(71) Applicant: COMMSCOPE TECHNOLOGIES LLC, Hickory, NC (US)

(72) Inventors: Bart Mattie Claessens, Hasselt (BE); Roger Joseph Alaerts, Langdorp (BE); Stefan Sepelev, Wavre (BE); Geert Van Genechten, Vorselaar (BE); Maarten Michiels, Herent (BE); Eddy Luc Cams, Bilzen (BE); Cornelia Van De Velde, Herselt (BE)

(21) Appl. No.: 18/041,645

(22) PCT Filed: Aug. 12, 2021
(86) PCT No.: PCT/US2021/045769

§ 371 Date: Feb. 14, 2023

Related U.S. Application Data
(60) Provisional application No. 63/231,407, filed on Aug. 10, 2021.
(60) Provisional application No. 63/160,132, filed on Mar. 12, 2021.
(60) Provisional application No. 63/065,570, filed on Aug. 14, 2020.

(51) Int. Cl. G02B 6/44

(52) U.S. Cl. CPC G02B 6/4455; G02B 6/44526

(57) ABSTRACT

Holders that anchor sheaths containing optical fibers. The holders include various anchoring and placement features for the sheaths held by the holders. In some examples, a labyrinthine passage is provided to secure the sheaths within the holder. In some examples, the holder includes a twist-to-anchor mechanism. In some examples, the holder includes a narrow and expandable lateral entry slot for sheaths that is in communication with a wide sheath holding volume.

### CROSS-REFERENCE TO RELATED APPLICATION

This application is being filed on Aug. 12, 2021 as a PCT International Patent Application and claims the benefit of U.S. Patent Application Serial Nos. 63/065,570, filed Aug. 14, 2020; 63/160,132, filed Mar. 12, 2021; and 63/231,407, filed Aug. 10, 2021; the disclosures of which are incorporated herein by reference in their entireties.

### TECHNICAL FIELD

The present disclosure relates to telecommunications enclosures, and more particularly to devices that anchor sheaths containing optical fibers to optical fiber organizers housed within telecommunications closures.

### BACKGROUND

Telecommunications systems typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures or “closures” are adapted to house and protect telecommunications components such as splices, termination panels, power splitters, wave division multiplexers, fiber management trays, cable organizing and routing components, etc.

It is often preferred for telecommunications enclosures to be re-enterable. The term “re-enterable” means that the telecommunications enclosures can be reopened to allow access to the telecommunications components housed therein without requiring the removal and destruction of the telecommunications enclosures. For example, certain telecommunications enclosures can include separate access panels that can be opened to access the interiors of the enclosures, and then closed to reseal the enclosures. Other telecommunications enclosures take the form of elongated sleeves formed by wrap around covers or half-shells having longitudinal edges that are joined by clamps or other retainers. Still other telecommunications enclosures include two half-pieces that are joined together through clamps, wedges or other structures.

Typically, telecommunications closures house a fiber organizing assembly having equipment for organizing fibers, storing fibers, and optically connecting provider side fibers to subscriber side fibers. A given closure can accommodate different types of optical connections between fibers, such as connector to connector connections and splice connections.

For some closures, cables enter the closure through sealed ports. The outer jackets of the cables are fixed to the organizer. Lengths of outer layers of the cables are stripped to expose sheaths containing loose optical fibers. The sheaths are routed to a fiber manager via sheath channels. Lengths of the sheaths are stripped to expose the optical fibers. The optical fibers are routed to fiber connectivity and storage equipment of the organizer.

The contents of International Patent Publication Numbers WO 2013/149846 published Oct. 10, 2013 and WO 2014/207210 published Dec. 31, 2014, are hereby incorporated by reference in their entireties.

### SUMMARY

In general terms, the present disclosure is directed to improvements in anchoring of optical fiber sheaths using sheath holders of optical fiber organizers of telecommunications closures.

In certain aspects, sheath holder modules define the sheath holders.

In certain aspects, the sheath holder modules are configured to be removably secured to a main body of the fiber organizer.

In certain aspects, the sheath holders are configured to maximize the number of sheaths that can be held per sheath holder or sheath holder module.

In certain aspects, the sheath holders are configured to accommodate sheaths of different transverse diameters.

In certain aspects, a given sheath holder is configured to accommodate sheaths of different transverse diameters at the same time.

In certain aspects, the sheath holders are configured to receive sheaths laterally, e.g., in a direction perpendicular or non-parallel to an elongate dimension of the sheaths.

Loading of sheaths into a sheath holder by feeding them along their elongate dimension can be unwieldy or impossible due to the stiffness and length of the sheaths. Accordingly, lateral insertion of sheaths sheath holders can be advantageous.

In certain aspects, the sheath holders are configured to securely hold sheaths while minimizing the number of component parts and the number of steps needed to install and secure fiber sheaths in the sheath holders.

According to certain aspects of the present disclosure, a sheath holder module for anchoring one or more sheaths of optical fibers at a fiber organizer of a telecommunications closure, comprises: a body, defining: a first axis, a second axis, and a third axis that are mutually perpendicular to one another; an outer surface; an inner surface facing away from the outer surface, the inner surface defining a sheath holding volume configured to hold one or more sheaths having an elongate dimension substantially parallel to the first axis; and a slot in communication with the sheath holding volume, the slot being elongate parallel to the first axis and configured to allow a sheath to be inserted into the sheath holding volume in a direction perpendicular to the first axis, a largest width dimension of the slot perpendicular to the elongate dimension being smaller than a parallel largest width dimension of the sheath holding volume.

According to further aspects of the present disclosure, a sheath holder module for anchoring one or more sheaths of optical fibers at a fiber organizer of a telecommunications closure, comprises: a body, defining: a first axis, a second axis, and a third axis that are mutually perpendicular to one another; a wall defining a labyrinthine sheath passage in a plane perpendicular to the first axis, the labyrinthine sheath passage being configured to hold a plurality of sheaths having an elongate dimension substantially parallel to the first axis.

According to further aspects of the present disclosure, a fiber organizer for a fiber optic closure includes: a fiber manager including structures for routing optical fibers, the fiber manager being configured to mount a frame that can mount a tray support for pivotally mounting fiber management trays, the fiber manager being further configured to mount sheath holder modules in an arrangement, the arrangement defining at least three rows of sheath holder bodies each configured to anchor one or more sheaths of the optical fibers, wherein each row defines a row axis extending through centers of the sheath holder bodies of the row, the row axis of one of the rows projected in a reference plane being perpendicular to the row axis of each of the other two rows projected in the reference plane.

As used herein with respect to a passage or a sheath passage, the term labyrinthine means that a path along a center of the passage in the elongate dimension of the passage changes direction by at least 90 degrees at each of at least one corner.

According to further aspects of the present disclosure, a sheath holder module for anchoring one or more sheaths of optical fibers at a fiber organizer of a telecommunications closure, comprises: a first body including an inner surface and an outer surface; and a second body including an inner surface and an outer surface, the first and second bodies cooperating to define a sheath holding volume configured to hold one or more sheaths, the first and second bodies configured to twistingly cooperate at an interface between the inner surfaces of the first and second bodies to anchor one or more sheaths between the inner surfaces of the first and second bodies within the sheath holding volume.

According to further aspects of the present disclosure, a sheath holder module for anchoring one or more sheaths of optical fibers at a fiber organizer of a telecommunications closure, includes: a body defining a first axis, a second axis, and a third axis that are mutually perpendicular to one another, the body including a wall having: an outer surface; and an inner surface facing away from the outer surface, the inner surface defining a sheath holding volume configured to hold one or more sheaths having an elongate dimension substantially parallel to the first axis, wherein the wall defines a slot in communication with the sheath holding volume, the slot being elongate parallel to the first axis and configured to allow a sheath to be inserted into the sheath holding volume in a direction perpendicular to the first axis; and wherein the body includes a sheath retention tab projecting from a fixed end at the inner surface to a free end along a direction that is perpendicular to the first axis, and oblique to each of the second axis and the third axis.

According to further aspects of the present disclosure, a fiber optic organizer for a telecommunications closure, includes: a fiber manager; and a sheath holder module having a body including a wall defining a sheath holder volume and a fiber retention lip, the sheath holder module defining a sheath termination zone between the sheath holder volume and the fiber retention lip, the sheath holder module being connected to the fiber manager and positioned relative to the fiber manager such that any axial growth of a sheath containing an optical fiber and held in the sheath holding volume that causes an axial end of the sheath to advance within, but not beyond, the sheath termination zone cannot cause the optical fiber to bend beyond a minimum bend radius of the optical fiber within the fiber manager.

According to further aspects of the present disclosure, a method includes: providing a fiber manager; providing a sheath holder module having a body including a wall defining a sheath holder volume, the sheath holder module defining a sheath termination zone; connecting the sheath holder module to the fiber manager at a location on the fiber manager; fixing a cable jacket of a cable containing an optical fiber relative to the fiber manager; laterally inserting a sheath containing the optical fiber into the sheath holder volume; and stripping the sheath such that an axial end of the sheath is positioned in the sheath termination zone and such that the optical fiber continues from the sheath beyond the sheath holder module within the fiber manager.

According to further aspects of the present disclosure, a method includes: providing a sheath containing an optical fiber, the sheath defining a longitudinal axis; inserting the sheath into a sheath holding volume defined by a sheath holder module, the inserting including: a first motion of the sheath, followed by; a second motion of the sheath, the first motion being a motion along a first direction that is substantially perpendicular to the axis and through a slot defined by the module, the second motion being along a second direction that is substantially perpendicular to the axis and through a space defined by the module, wherein the first direction and the second direction define an acute angle therebetween.

According to further aspects of the present disclosure, a method includes: providing a sheath containing an optical fiber, the sheath defining a longitudinal axis; inserting the sheath into a sheath holding volume defined by a sheath holder module, the inserting including: a first motion of the sheath, followed by; a second motion of the sheath, the first motion being a motion along a first direction that is substantially perpendicular to the axis and through a slot defined by the module, the second motion being along a second direction that is substantially perpendicular to the axis, wherein the first direction and the second direction are substantially perpendicular to each other.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of an example telecommunications closure.

FIG. 2 is a perspective view of an optical fiber organizer that can be housed in the telecommunications closure of FIG. 1.

FIG. 3 is a further perspective view of the optical fiber organizer of FIG. 2.

FIG. 4 is an end view of the optical fiber organizer of FIG. 2.

FIG. 5 is a perspective view of a fiber managing module of the organizer of FIG. 2.

FIG. 6 is an exploded view of the fiber managing module of FIG. 5.

FIG. 7 is a planar view of a portion of the fiber managing module of FIG. 5.

FIG. 8 is a perspective view of a portion of a sheath holder module of the fiber managing module of FIG. 5.

FIG. 9 is a further perspective view of the sheath holder module of FIG. 8.

FIG. 10 is a planar view of the sheath holder module of FIG. 8.

FIG. 11 is a planar view of a portion of a fiber managing module including further example sheath holder modules according to the present disclosure.

FIG. 12 is a further planar view of the fiber managing module of FIG. 11.

FIG. 13 is a perspective view of the fiber managing module of FIG. 11.

FIG. 14 is a perspective view of a portion of the fiber managing module of FIG. 11.

FIG. 15 is a perspective view of a portion of the sheath holder module of the fiber managing module of FIG. 11.

FIG. 16 is a planar view of a portion of the sheath holder module of FIG. 11, schematically showing five sheaths being held.

FIG. 17 is a planar view of a portion of the sheath holder module of FIG. 11, schematically showing 10 sheaths being held.

FIG. 18 is a perspective view of a further portion of the sheath holder module of FIG. 11.

FIG. 19 is planar view of the sheath holder module of FIG. 11.

FIG. 20 is a perspective view of a portion of the sheath holder module of FIG. 11.

FIG. 21 is a cross-sectional view of a portion of the sheath holder module of FIG. 11.

FIG. 22 is a perspective view of a further example sheath holder module in accordance with the present disclosure.

FIG. 23 is a planar view of a portion of the sheath holder module of FIG. 22.

FIG. 24 is a perspective view of a further example sheath holder module in accordance with the present disclosure.

FIG. 25 is an exploded perspective view of a further example sheath holder module according to the present disclosure, and including a portion of a sheath.

FIG. 26 is a perspective view of the sheath holder module and sheath of FIG. 26, the sheath holder module being in an unclamped or staged configuration.

FIG. 27 is a perspective view of the sheath holder module and sheath of FIG. 26, the sheath holder module being in a clamped configuration.

FIG. 28 is a cross-sectional view of the sheath holder module and sheath of FIG. 26, the sheath holder module being in a clamped configuration.

FIG. 29 is a perspective view of the components of the sheath holder module of FIG. 26.

FIG. 30 is a perspective view of a further example optical fiber organizer that can be housed in a telecommunications closure.

FIG. 31 is a further perspective view of the organizer of FIG. 30.

FIG. 32 is a further perspective view of the organizer of FIG. 30.

FIG. 33 is a further perspective view of the organizer of FIG. 30.

FIG. 34 is a front view of the organizer of FIG. 30.

FIG. 35 is a side view of the organizer of FIG. 30.

FIG. 36 is a rear view of the organizer of FIG. 30.

FIG. 37 is a further side view of the organizer of FIG. 30.

FIG. 38 is a bottom view of the organizer of FIG. 30.

FIG. 39 is a perspective view of a further example telecommunications closure.

FIG. 40 is a partially exploded, perspective view of the closure of FIG. 39.

FIG. 41 is a perspective view of the optical fiber organizer of FIG. 40.

FIG. 42 is an enlarged view of the called-out portion in FIG. 41.

FIG. 43 is a partially exploded, perspective view of the organizer of FIG. 40, and showing the tray area demarcation cover in a pivoted open position.

FIG. 44 is a perspective view of a further example sheath holder module according to the present disclosure, the sheath holder module being a component of the organizer of FIG. 40.

FIG. 45 is a further perspective view of the sheath holder module of FIG. 44.

FIG. 46 is a side view of the sheath holder module of FIG. 44.

FIG. 47 is a front planar view of the sheath holder module of FIG. 44.

FIG. 48 is a bottom planar view of the sheath holder module of FIG. 44.

FIG. 49 is a top planar view of the sheath holder module of FIG. 44.

FIG. 50 illustrates sheaths holding fibers of optical cables anchored to a fiber optic organizer, the sheaths being held by multiple of the sheath holder modules of FIG. 44.

FIG. 51 illustrates inserting a sheath into the sheath holder module of FIG. 44.

FIG. 52 illustrates sheaths that have been inserted into the sheath holder module of FIG. 44 and are self-retained in the sheath holding volume of the module.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

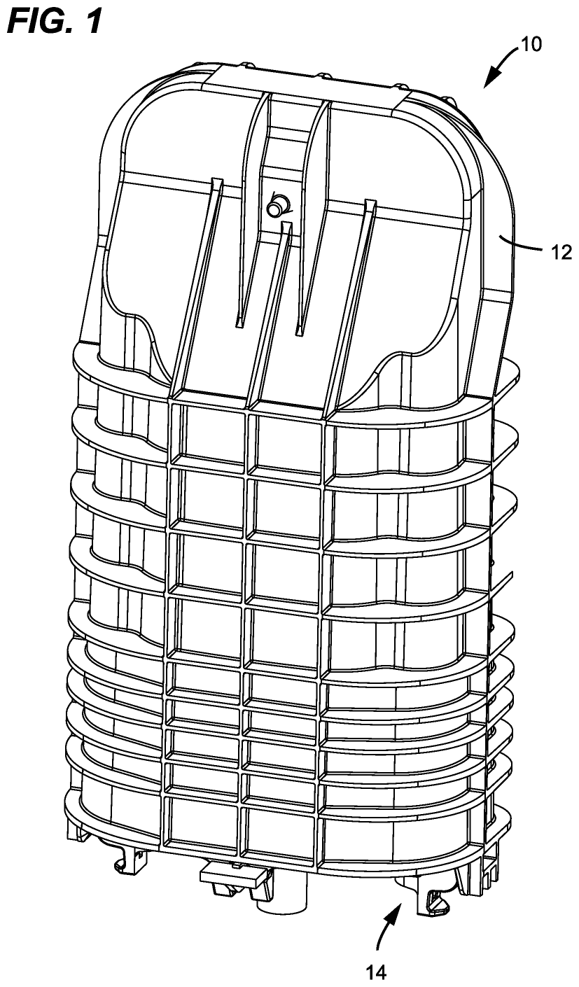

Referring to FIG. 1, an example telecommunications closure 10 includes a first housing piece, or cover 12, and a second housing piece, or base 14. The base 14 and the cover 12 cooperate to define a sealable and re-enterable closure volume for managing optical fiber connectors. The base 14 defines sealable cable ports through which cables carrying optical fibers enter the closure. The cables entering the closure can include, for example, feeder cables, distribution or drop cables, and branch cables. Feeder cables are network supplier side cables. Distribution cables are subscriber side cables. The fibers of feeder cables can be connected to, e.g., fibers of the distribution cables using a fiber organizer housed in the interior volume of the closure 10. Branch cables can connect the closure to another closure or fiber management node. Fibers of a feeder cable or incoming branch cable can be connected to fibers of an outgoing branch cable using the fiber organizer housed in the interior volume of the closure 10.

The fiber organizer housed in the closure 10 can include various fiber management structures and features to connect fibers of cables entering the closure. For example, the organizer can include fiber splice holders for holding splice bodies of optical fibers that are spliced to each other, optical fiber connector storage for storing connectors of connectorized fibers, adapters for operatively connecting two connectorized fibers, splitters, wave division multiplexers, and so forth.

Not all cables entering the closure need to be connected to other cables entering the closure. For example, optical fibers of one or more of the cables entering to the closure can be sleeved in protective sheaths that are stored in loops within the loop storage area defined by the fiber organizer housed in the interior volume of the closure 10. The unused fibers can be stored until optical connections with those fibers are needed.

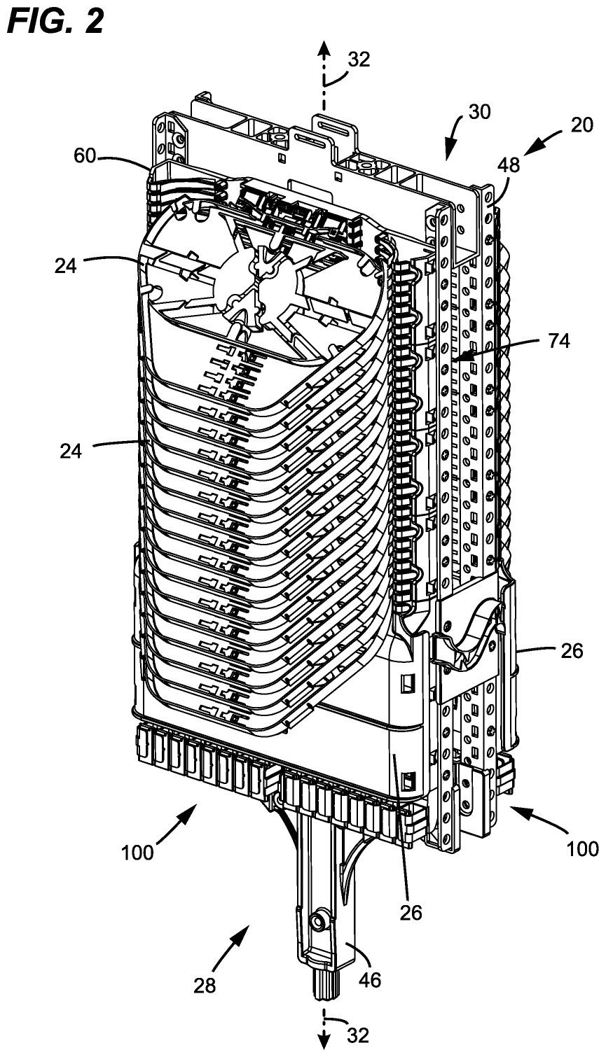

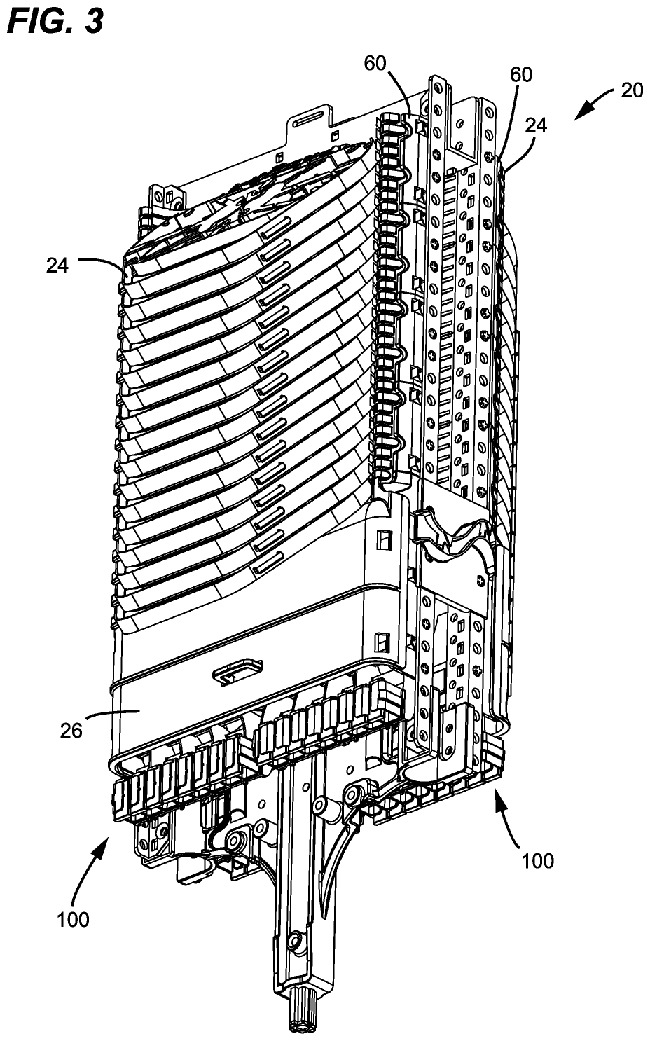

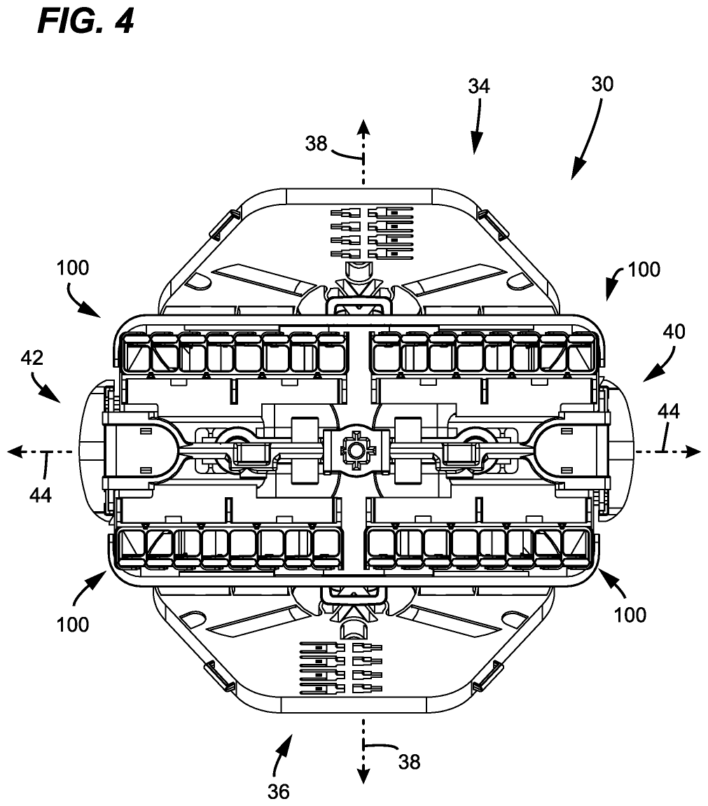

Referring to FIGS. 2-4, an example fiber organizer 20 is shown. The organizer 20 can be housed in the closure 10 of FIG. 1.

The organizer 20 extends from a bottom (or bottom side) 28 to a top (or top side) 30 along a first axis 32 defining a vertical dimension of the organizer. The organizer 20 extends from a front (or front side) 34 to a back (or back side) 36 along a second axis 38 defining a first horizontal dimension of the organizer. The organizer 30 extends from a right side (or first lateral side) 40 to a left side (or second lateral side) 42 along a third axis 44 defining a third horizontal dimension of the organizer. The first, second, and third axes 32, 38 and 44 are mutually perpendicular. A handle 46 of the organizer 20 allows the organizer 20 to be easily inserted in, and removed from, the cover 12 of the closure 10 (FIG. 1).

Terms such as top, bottom, vertical, horizontal, left, right, and related terms, as used herein, are for ease of description in relating orientations of components relative to one another, and do not limit how the assemblies of these components or the components themselves may be used or situated in practice.

The organizer 20 includes a frame 48 to which are mounted tray supports 60. Each tray support 60 is configured to pivotally support a plurality of fiber management trays 24.

Sheaths of optical fibers from cables entering the closure are anchored in sheath holder arrangements 100, which will be described in greater detail below. Sheaths of fibers that are not connected to other fibers using the organizer 20 can be stored in loops in the loop storage volume 74 defined by the frame 48.

A fiber manager 26 is mounted to each of the front and back of the frame 48, the fiber managers 26 facing away from each other. Each fiber manager 26 is mounted to the frame 48 below the corresponding tray support 60.

Fibers can be spliced to each other at splice bodies that are held in the splice holding area of a desired tray 24.

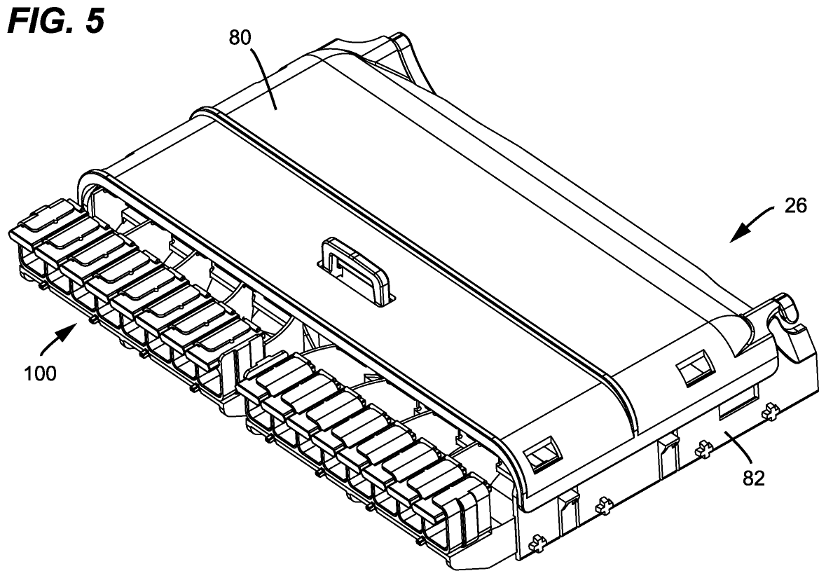

Referring to FIGS. 5-7, each fiber manager 26 includes a cover 80 and a body 82. The body 82 includes spool structures 84, 86. The spool structures 84, 86 allow fibers entering via the corresponding sheath holder arrangements 100 from cables entering the closure to be routed and/or redirected to a tray support 60. The spool structures 84, 86, are configured to comply with the fibers' minimum bend radii. The fibers managed on the fiber manager 26 can be loose fibers or sheaths of fibers.

The sheath holder arrangement 100 includes a base 102 that is removably attached to the body 82 of the fiber manager 26 with latch arms 104 having catches 106 that lockingly engage the body 82 by being inserted in openings 90. The sheath holder arrangement 100 also includes two sheath holder modules 110 that removably attached to the base 102.

Various embodiments of sheath holder modules in accordance with the present disclosure will now be described. The sheath holder modules of the present disclosure are configured to facilitate anchoring of fiber sheaths routed to a fiber organizer of a telecommunications closure. Anchoring of sheaths can minimize unwanted tangling or overlapping of fibers, which can result in unwanted tugging of fibers. Anchoring of sheaths can also facilitate orderly routing and organization of fibers on the fiber organizer. The sheath holder modules of the present disclosure include features that allow the holder modules to accommodate sheaths of different transverse diameters, and that can provide improved installation and anchoring of sheaths with minimal parts.

Bodies of sheath holder modules according to the present disclosure can be constructed of a flexibly resilient and rigid material, such as a metal, or a molded polymeric material.

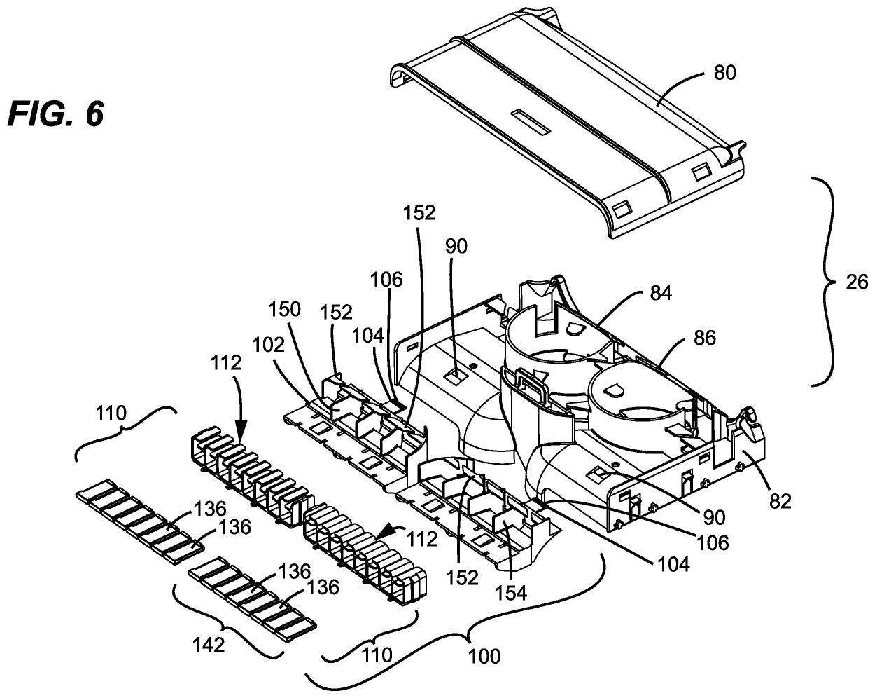

Referring to FIGS. 6-10, the sheath holder module 110 is configured to anchor one or more sheaths of optical fibers. The module 110 includes a body 112. The body 112 defines a first axis 114, a second axis 116, and a third axis 118 that are mutually perpendicular to one another. The body 112 includes walls 120 each having an outer surface 122 and an inner surface 124 facing away from the outer surface 122.

Each inner surface 124 defines a sheath holding volume 126 configured to hold one or more sheaths having an elongate dimension substantially parallel to the first axis 114. The walls 120 are configured to at least substantially surround, parallel to the plane P1, sheaths anchored in the sheath holding volume 126. For example, referring to FIG. 6, a portion of a sheath 128 is shown having a longitudinal dimension at least substantially parallel to the first axis 114 and a round, hollow cross-section perpendicular to the longitudinal dimension that defines a transverse diameter 130 (including the sheath and the interior hollow). The sheath 128 can hold optical fibers 129. In this example, each body 112 defines eight sheath holding volumes 126. Alternatively, a module body can define more or fewer sheath holding volumes. Alternatively, each sheath holding volume can be considered to be defined by its own discrete sheath module body, and in this example, eight such discrete bodies are interconnected to one another and aligned parallel to the second axis 116. The discrete module bodies can be interconnected with couplers or form a unitary structure as in the example shown.

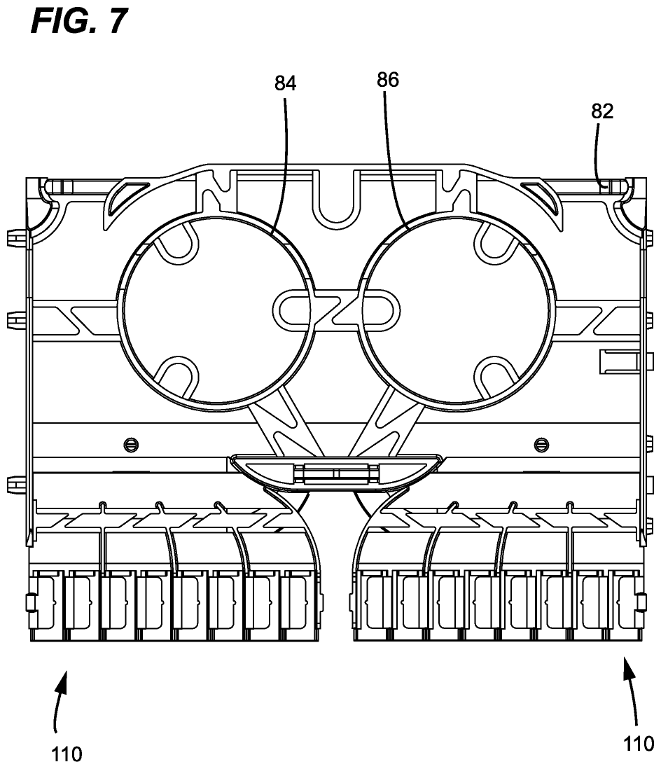

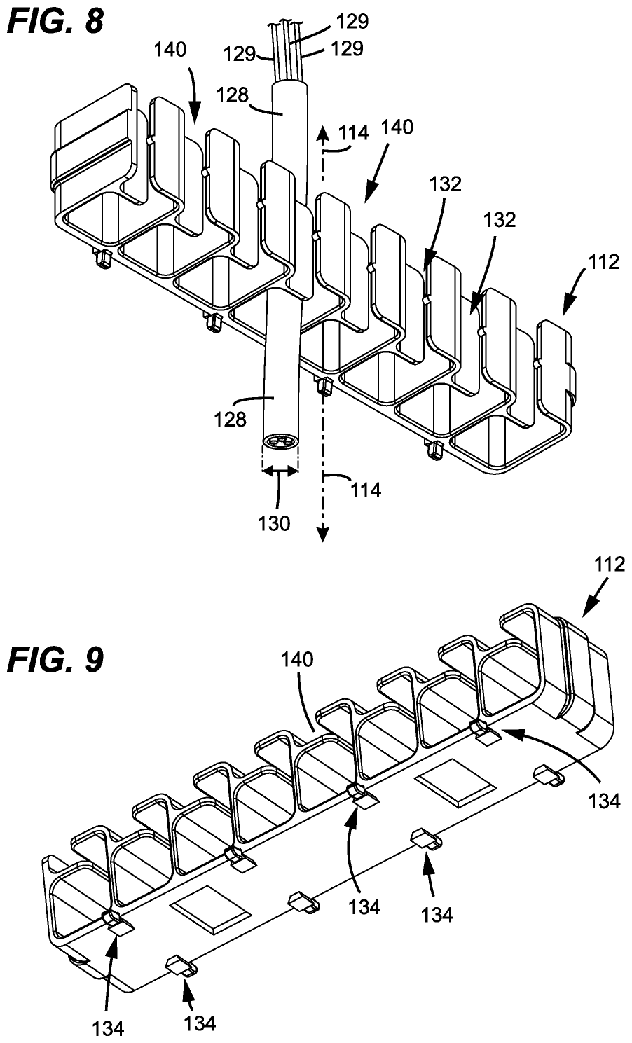

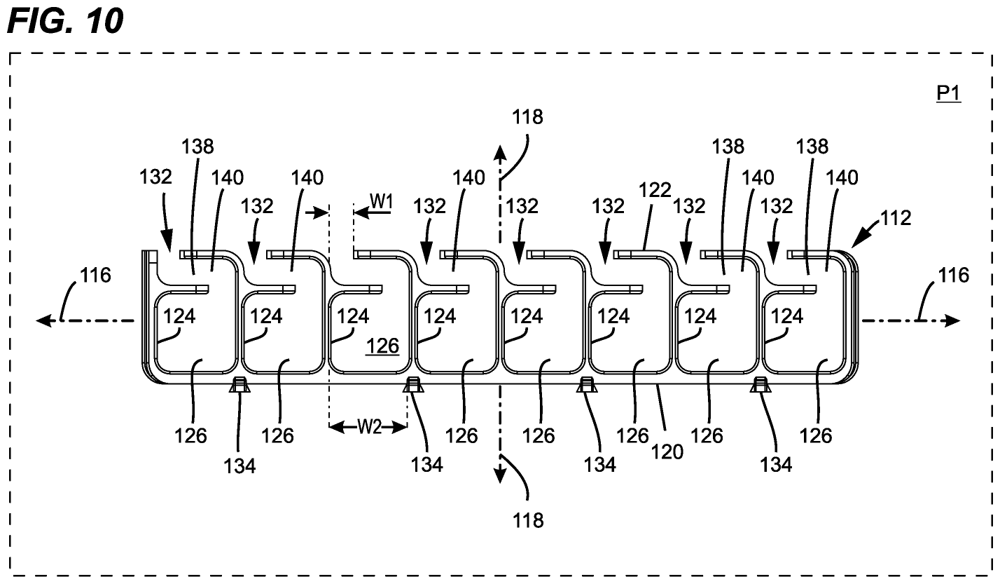

The body 112 defines, for each sheath holding volume 126, a slot 132 that is in communication with the corresponding sheath holding volume 126. Each slot 132 is elongate parallel to the first axis 114 and is configured to allow a sheath to be inserted into the corresponding sheath holding volume 126 in a direction perpendicular to the first axis 114 (FIG. 8). A largest width dimension W1 of each slot 132 perpendicular to the elongate dimension is smaller than a parallel largest width dimension W2 of the corresponding sheath holding volume 126 (FIG. 10). In some examples, the width W2 is at least twice, at least three times, at least four times or more, as large as the width W1. Thus, each slot 132 defines a relatively tight lateral entryway for a sheath into the corresponding sheath holding volume, which can provide for improved retention of a sheath within the sheath holding volume 126, e.g., by minimizing unwanted passage of a sheath from the sheath holding volume through the slot 132, while also providing a sheath holding volume 126 that can anchor multiple sheaths, e.g., at least two, at least four, at least six, at least eight, or more sheaths of the same or different transverse diameters.

The body 112 includes couplers 134 for releasably attaching the sheath holder module 110 to the base 102. The couplers 134 can be received in complementary recesses of the base 102 by interlocking fit to attach the body 112 and the base 102. The base 102 includes walls 150 and 154, and fiber retaining lips 152. The walls 150, 154 are curved to gently direct sheaths (e.g., tubes) or fibers to opposite lateral sides of the body 82 of the fiber manager 26.

The module 110 includes covers 136. A cover 136 can be inserted into a portion 138 of a labyrinthine sheath passage 140 defined by each wall 120 and extending from the corresponding slot 132 to the sheath holding volume 126. The sheath passage 140 is labyrinthine in a plane P1 that is perpendicular to the first axis 114, and defined by the axes 116 and 118.

Each cover 136 can be an elastomeric body that is sized to be retained within the labyrinthine sheath passage by frictional fit with the inner surface 124. The labyrinthine sheath passage 140 has a width W3 parallel to the axis 18 that is smaller than the width W2. In some examples, W2 is at least twice, at least three times, at least four times or more, as large as the width W3. The configuration of the slot 132 and labyrinthine sheath passage 140 allows for lateral insertion of multiple sheaths to be anchored in the sheath holding volume 126, while inhibiting sheaths from passing out of the sheath volume 126 through the passage 140 and slot 132. In some examples, the width W3 is less than the transverse width 130 (FIG. 8) of the sheaths. In some examples, the sheath passage 140 is configured to resiliently expand (e.g., the walls defining the passage can flex) to allow passage of a sheath therethrough that is wider than the passage. The walls can then resiliently return to their unflexed configuration, causing the width of the passage to contract to a size that is smaller than a transverse width of the sheath, once that the sheath has entered the sheath volume. The relative sizing of the passage and the sheath can help to retain the sheath in the sheath volume.

As shown in FIG. 6, the covers 136 can be constructed in interconnected groups 142. A group 142 of covers 136 can be sized to be inserted as a group into a row of portions 138. Alternatively, individual covers 136 or smaller groups of covers 136 can be torn away from the remainder of the group 142 and inserted into passage portions 138.

In examples, the body 112 is constructed of a flexibly resilient material such that the slot 132 expands as a sheath passes through the slot and resiliently returns to its rest size (e.g., shrinks) when the sheath has passed through the slot 132. Sizing the slot 132 relative to a sheath in this manner can further improve retention of the sheath within the sheath holding volume 126.

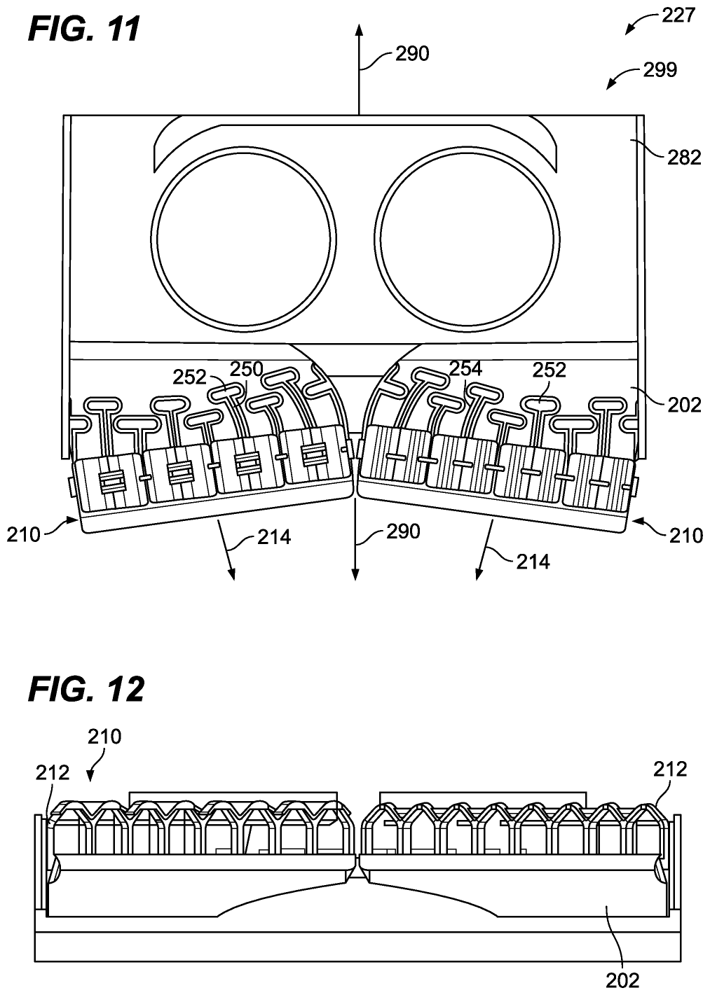

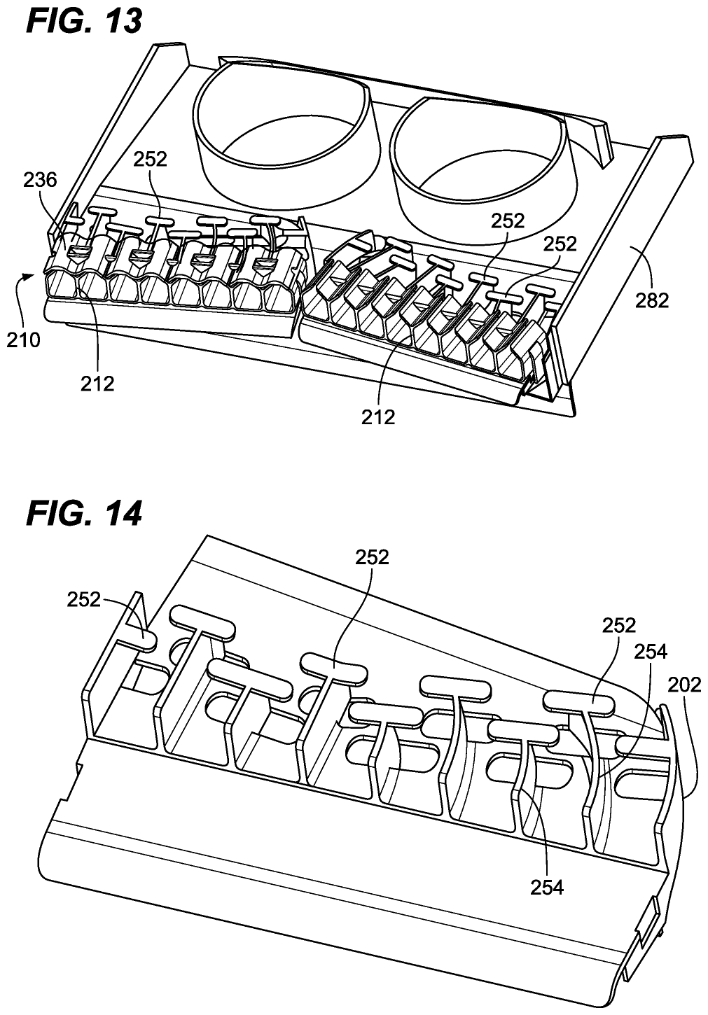

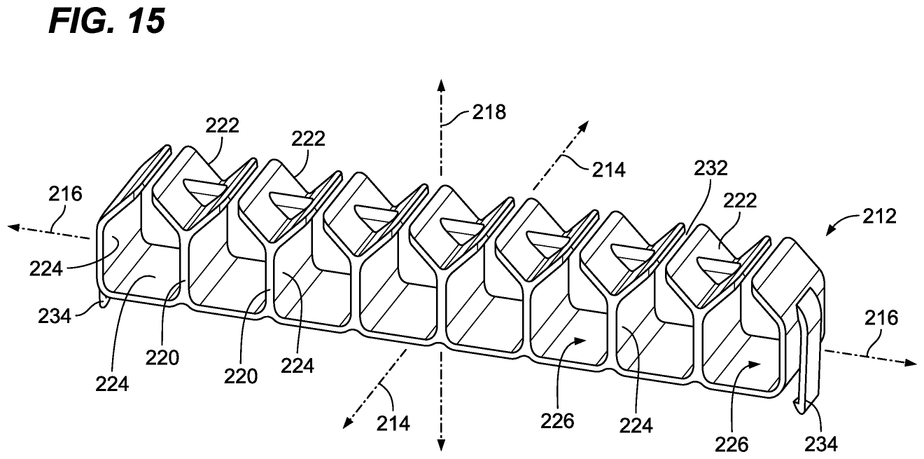

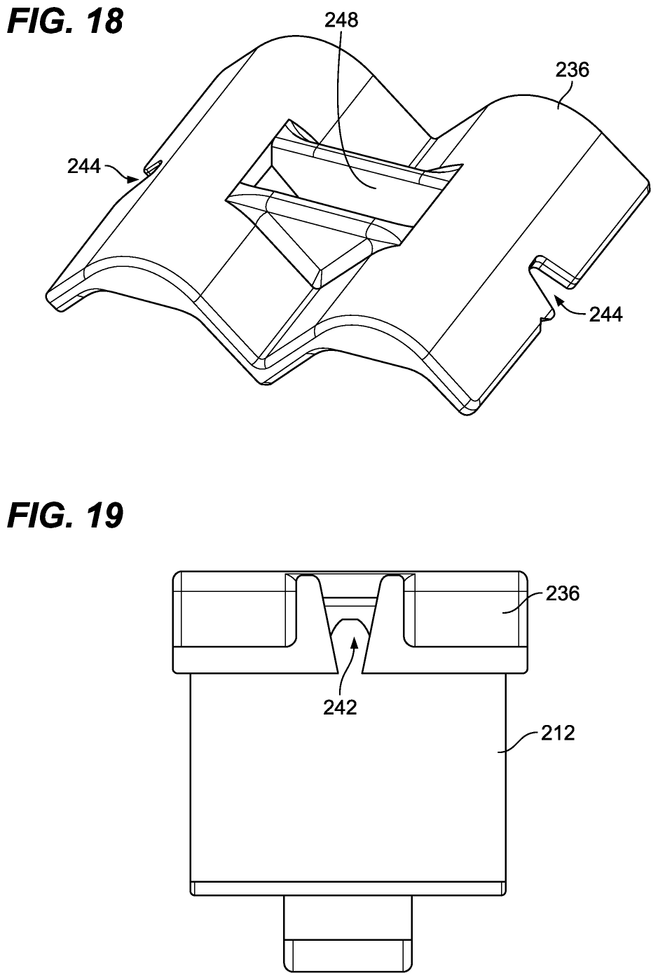

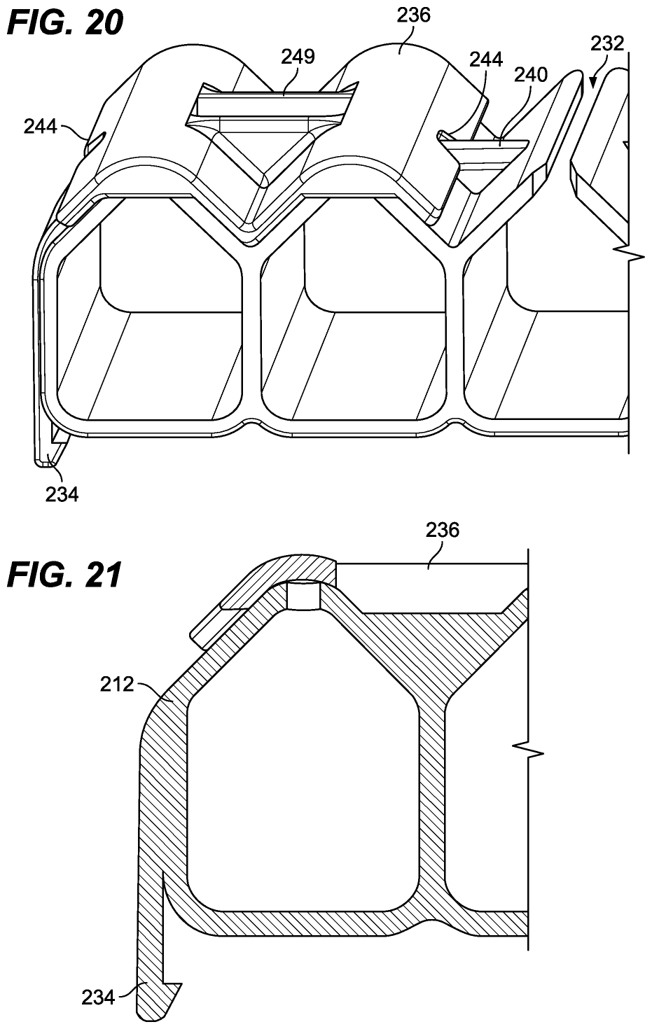

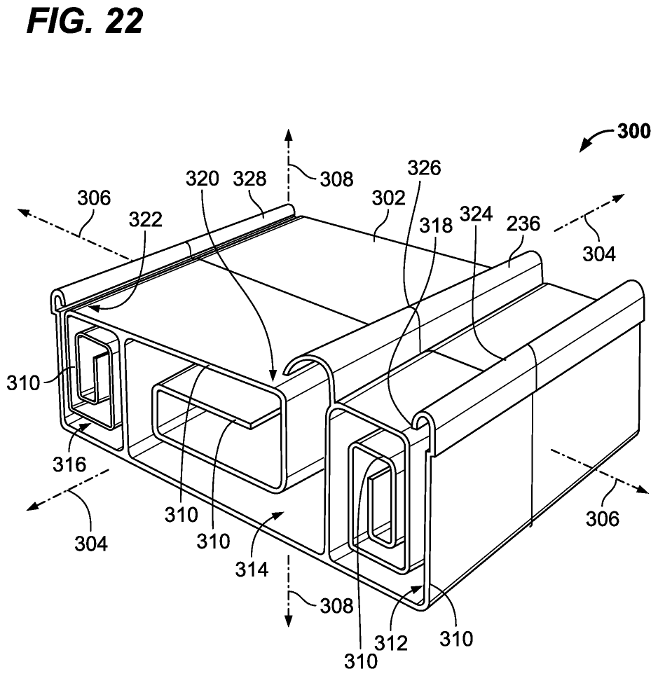

Referring to FIGS. 11-21, a further embodiment of a sheath holder module and corresponding fiber manager will be described.

The sheath holder module 210 is configured to anchor one or more sheaths of optical fibers. The module 210 includes a body 212. The body 212 defines a first axis 214, a second axis 216, and a third axis 218 that are mutually perpendicular to one another. The body 212 includes walls 220 each having an outer surface 222 and an inner surface 224 facing away from the outer surface 222.

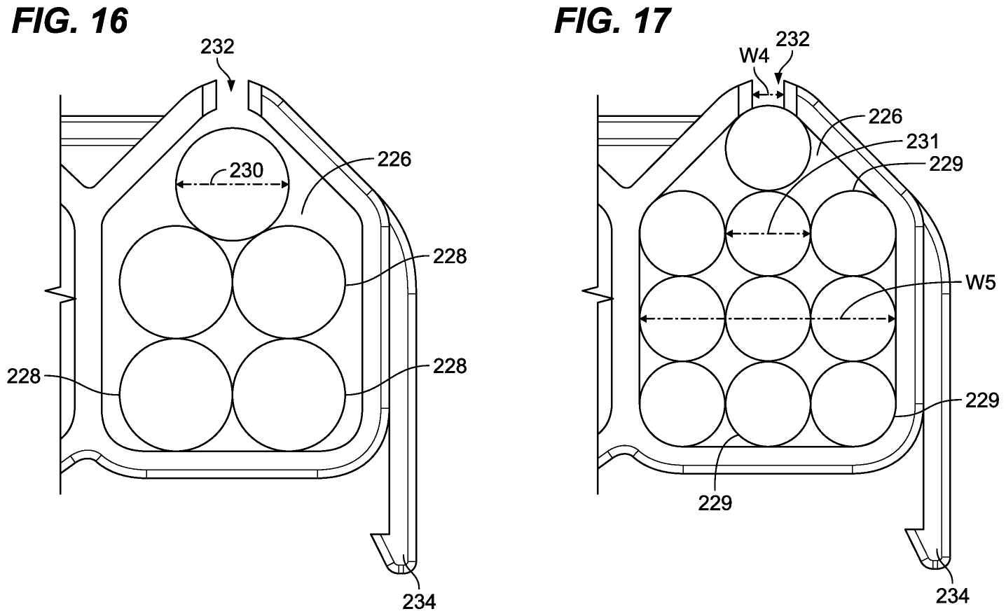

Each inner surface 224 defines a sheath holding volume 226 configured to hold one or more sheaths having an elongate dimension substantially parallel to the first axis 214. The walls 220 are configured to at least substantially surround sheaths anchored in the sheath holding volume 126. For example, referring to FIG. 16, the sheath holding volume 226 is anchoring five sheaths 228, each sheath 228 having a longitudinal dimension at least substantially parallel to the first axis 214 and a round, hollow cross-section perpendicular to the longitudinal dimension that defines a transverse diameter 230.

Referring to FIG. 17, the sheath holding volume 226 is anchoring nine sheaths 229, each sheath 229 having a longitudinal dimension at least substantially parallel to the first axis 214 and a round, hollow cross-section perpendicular to the longitudinal dimension that defines a transverse diameter 231. The transverse diameter 231 is smaller than the transverse diameter 230, allowing more sheaths 229 to be anchored than sheaths 228. In some examples, sheaths of multiple sizes can be anchored in the same sheath holding volume 226. For both configurations and sheath sizes in FIGS. 16 and 17, the sheath holding volume 226 is sufficiently filled with sheaths, and the slot is sufficiently small such that the sheaths are anchored within the sheath holding volume 226. In this example, each body 212 defines eight sheath holding volumes 226.

Alternatively, a module body can define more or fewer sheath holding volumes. Alternatively, each sheath holding volume can be considered to be defined by its own discrete sheath module body, and in this example, eight such discrete bodies are interconnected to one another and aligned parallel to the second axis 216. The discrete module bodies can be interconnected with couplers or form a unitary structure as in the example shown.

The body 212 defines, for each sheath holding volume 226, a slot 232 that is in communication with the corresponding sheath holding volume 226. Each slot 232 is elongate parallel to the first axis 214 and is configured to allow a sheath to be inserted into the corresponding sheath holding volume 226 in a direction perpendicular to the first axis 214 (FIG. 8) and, in this example, parallel to the axis 218.

A largest width dimension W4 of each slot 232 perpendicular to the elongate dimension is smaller than a parallel largest width dimension W5 of the corresponding sheath holding volume 226. In some examples, the width W5 is at least twice, at least three times, at least four times or more, as large as the width W4. Thus, each slot 232 defines a relatively tight lateral entryway for a sheath into the corresponding sheath holding volume, which can provide for improved retention of a sheath within the sheath holding volume 226, e.g., by minimizing unwanted passage of a sheath from the sheath holding volume through the slot 232, while also providing a sheath holding volume 226 that can anchor multiple sheaths, e.g., at least two, at least four, at least six, at least eight, or more sheaths of the same or different transverse diameters.

The body 212 includes couplers 234 for releasably attaching the sheath holder module 210 to the base 202. The couplers 234 can be received in complementary recesses of the base 202 by latching engagement to attach the body 212 and the base 202. The base 202 includes walls 250 and 254, and fiber retaining lips 252. The walls 250, 254 are curved to gently direct sheaths (e.g., tubes) or fibers to opposite lateral sides of the body 282 of the fiber manager 227.

The module 210 includes covers 236. Each cover 236 is a cap configured to cover one or more of the slots 232. Notches 244 defined by each cover 236 are configured to snappingly receive ribs 240, 242 of the body 212 to lock the cover 236 to the body. With covers 236 locked to the body 212, the passage of sheaths positioned in the corresponding sheath holding volume is further inhibited.

In examples, the body 212 is constructed of a flexibly resilient material such that the slot 232 expands as a sheath passes through the slot and resiliently returns to its rest size (e.g., shrinks) when the sheath has passed through the slot 232. Sizing the slot 232 relative to a sheath in this manner can further improve retention of the sheath within the sheath holding volume 226.

Referring to FIG. 11, there are two sheath holder modules supported by an organizer having a main body which is a portion 299 of the main assembly. The modules are mounted such that the axes 214 of the sheath holder modules form oblique angles with the longitudinal axis 290 of the organizer. In addition, the axes 214 of the first and second sheath holder modules 210 are non-parallel to each other, with each module 210 angled away from the central axis 290 of the organizer. This orientation of the modules 210 can facilitate routing of fibers on opposite lateral sides of the manager 227.

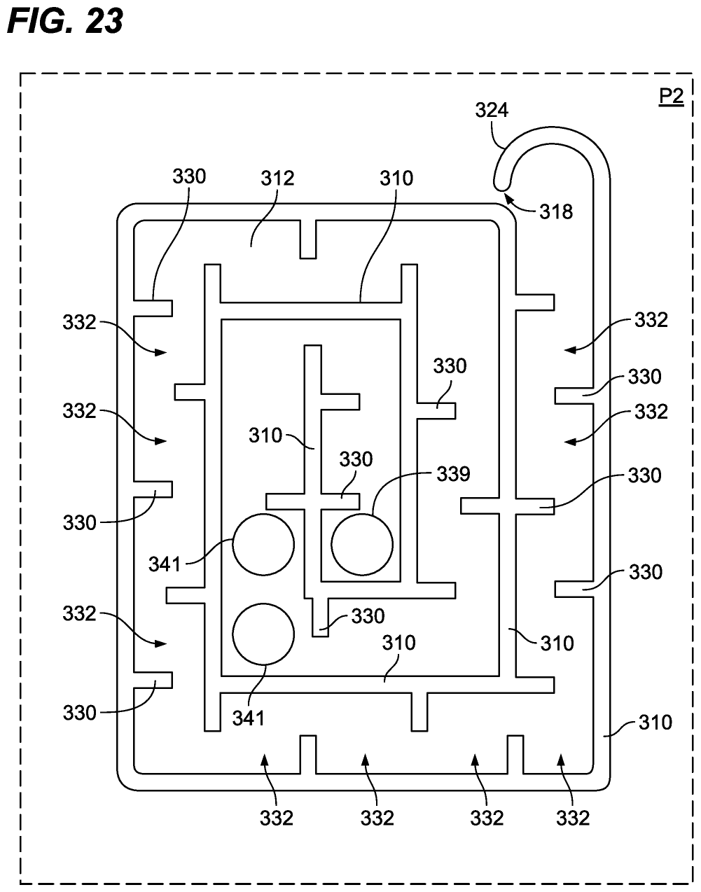

Referring to FIGS. 22-23, a further example sheath holder module 300 is shown that can be coupled to a fiber manager of a fiber organizer of a telecommunications closure. The sheath holder module 300 is configured for anchoring one or more sheaths of optical fibers. The module 300 includes a body 302 defining a first axis 304, a second axis 306 and a third axis 308 that are mutually perpendicular to one another.

The body includes spiraling walls 310 that define labyrinthine sheath passages 312, 314, 316 in a plane P2 perpendicular to the axis 304 and defined by the axes 306 and 308. The labyrinthine sheath passages 312, 314, 316 are each configured to hold and anchor a plurality of sheaths having an elongate dimension at least substantially parallel to the axis 304.

A slot 318, 320, 322 is provided as a lateral entry for sheaths into the corresponding sheath passage 312, 314, 316 with which the slot is in communication. The slot 318, 320, 322 is elongate parallel to the axis 304. The slot 318, 320, 322 allows loading of a sheath into the sheath passage in a direction perpendicular to the axis 304. A flexibly resilient flap 324, 326, 328 adjacent each slot 318, 320, 322 can help retain sheaths within the passages 312, 314, 316.

The body 302 defines plurality of ribs 330 projecting from the walls 310 perpendicularly to the axis 304 that partially define the labyrinthine sheath passage 312, 314, 316. The ribs 330 project alternatingly from opposing sides of the passage. The ribs 330 define discrete anchoring positions 332 for sheaths within the sheath holding volume. In some examples, an anchoring position 332 anchors only one sheath, such as the schematically represented sheath 339 (FIG. 23). In some examples, an anchoring position 332 anchors multiple sheaths, such as the schematically represented sheaths 341. The body 302 can be constructed of a flexibly resilient material such that the slot expands as a sheath passes through the slot and shrinks when the sheath has passed through the slot.

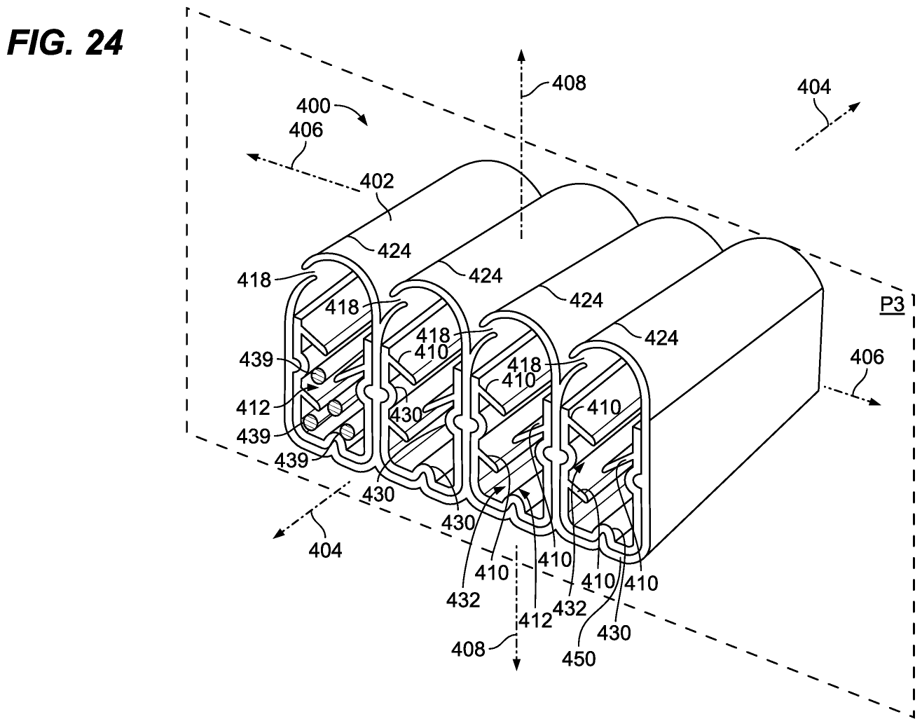

Referring to FIG. 24, a further example sheath holder module 400 is shown that can be coupled to a fiber manager of a fiber organizer of a telecommunications closure. The sheath holder module 400 is configured for anchoring one or more sheaths of optical fibers. The module 400 includes a body 402 defining a first axis 404, a second axis 406 and a third axis 408 that are mutually perpendicular to one another.

The body 402 includes walls 410 alternatingly projecting from opposing surfaces that define labyrinthine sheath passages 412 in a plane P3 perpendicular to the axis 404 and defined by the axes 406 and 408. The labyrinthine sheath passages 412 are each configured to hold and anchor a plurality of sheaths having an elongate dimension at least substantially parallel to the axis 404.

A slot 418 is provided as a lateral entry for sheaths into the corresponding sheath passage 412 with which the slot is in communication. The slot 418 is elongate parallel to the axis 404. The slot 418 allows loading of a sheath into the sheath passage in a direction perpendicular to the axis 404. A flexibly resilient flap 424 at each slot 418 can help retain sheaths within the passages 412.

The body 402 defines a plurality of ribs 430 projecting from the walls 410 perpendicularly to the axis 404 that partially define the labyrinthine sheath passage 412. The ribs 430 define discrete anchoring positions 432 for sheaths within the sheath passage 412, such as the schematically represented sheaths 439. Each anchoring position 432 can anchor one or more sheaths, depending on the transverse dimension of the sheaths.

The body 402 can be constructed of a flexibly resilient material such that the slot expands as a sheath passes through the slot and shrinks when the sheath has passed through the slot. Optionally, the walls 410 are constructed separately from a base portion 450 of the body 402. For example, the walls 410 can be constructed of elastomeric material, while the base portion 450 can be constructed of a more rigid polymer. Alternatively, the walls and base portion can be constructed of the same material and/or be of unitary construction. The walls 410 can be configured to resiliently bend to permit loading of sheaths, with each wall 410 resiliently returning to its unbent configuration after a sheath is loaded into the adjacent anchoring position 432.

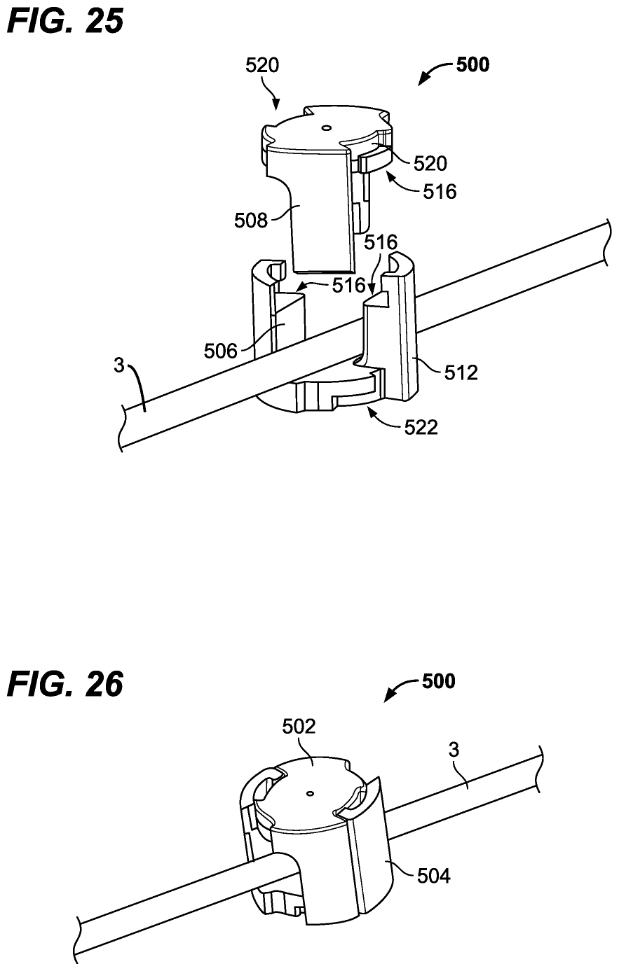

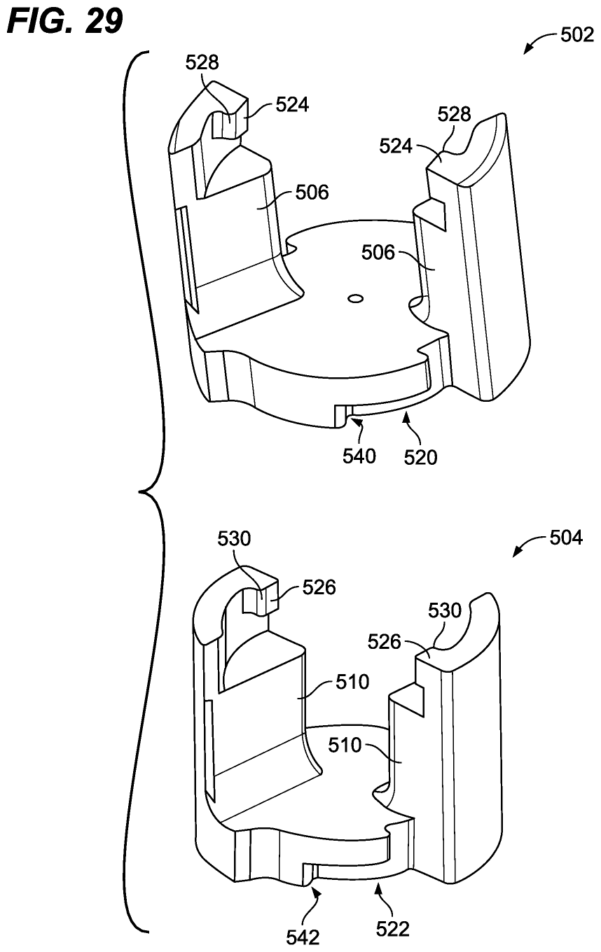

Referring now to FIGS. 25-29, a further example sheath holder module 500 according to the present disclosure for anchoring one or more sheaths of optical fibers at a fiber organizer of a telecommunications closure and showing a portion of a sheath 3, will be described.

The module 500 includes a first body 502 and second body 504. In some examples, the first and second bodies are of identical construction. The first body 502 includes an inner surface 506 and an outer surface 508. The second body 504 includes an inner surface 510 and an outer surface 512.

The first and second bodies 502, 504 cooperate with each other to define a sheath holding volume 514 configured to hold one or more sheaths 3. For example, sheaths can be stacked one atop another within the sheath holding volume parallel to the rotation axis 532 that is at least substantially perpendicular to the longitudinal axis of the sheath(s) when anchored by the module 500.

In particular, the first and second bodies 502, 504 are configured to twistingly cooperate at an interface 516 between the inner surfaces 506, 510 of the first and second bodies 502, 504 to anchor one or more sheaths between the inner surfaces of the first and second bodies within the sheath holding volume 514. In examples, the first and second bodies are configured to cooperate to secure sheaths of different transverse dimensions, e.g., by varying the magnitude of squeeze force applied to the outside of the sheath by the inner surfaces 506, 510. The inner surfaces 506, 510 can define edges 550, 552 that can grip or dig into the wall of the sheath 3 for improved anchoring of the sheath 3.

The interface 516 includes twist guiding structures and interlocking structures on the first and second bodies 502, 504. The twist guiding structures include a curved groove 520, 522 on each of the first and second bodies 502, 504, that receives and guides in a rotating motion a tooth 524, 526 of the other of the first and second bodies. The interlocking structures include catches 528, 530 that snappingly and releasably interlock with each other when one of the first and second bodies is twisted relative to the other of the first and second bodies by a predetermined rotation magnitude. The rotation is a rotation about a rotation or twist axis 532, and the predetermined rotation magnitude can be, e.g., between about 5 degrees and about 45 degrees, or outside of this range. In the example shown, the predetermined rotation magnitude is about 20 degrees once the teeth 524, 526 engage the beginning of the corresponding grooves 520, 522.

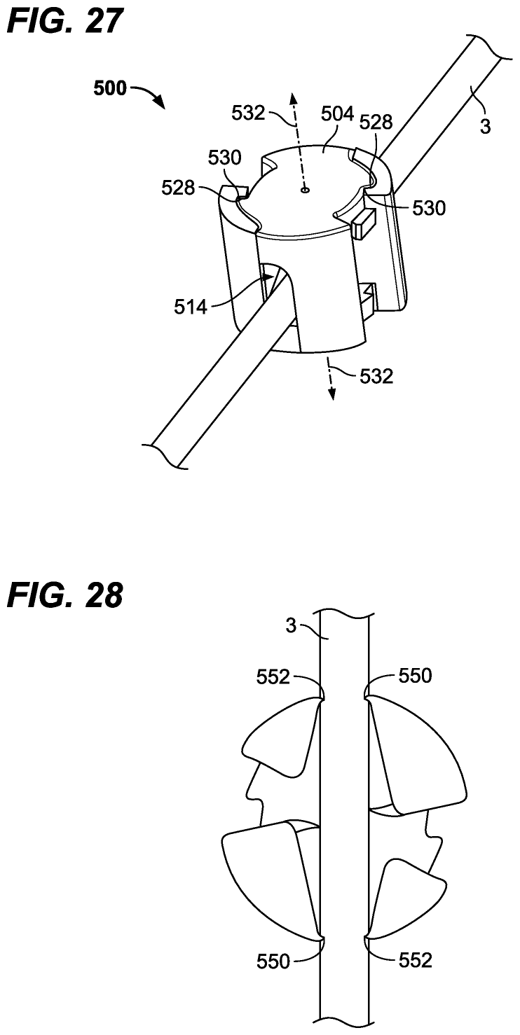

The interface 516 includes a twist stop 540, 542 defining the end of the corresponding groove 520, 522 of the first and second bodies 502, 504. Engagement of the tooth 524, 526 with the corresponding twist stop 540, 542 can prevent twisting of the first and second bodies relative to each other beyond the predetermined rotation magnitude. In FIG. 26, the first and second bodies 502 and 504 are in an engaged, staged and unclamped configuration prior to a twist to anchor motion. In FIG. 27, the first and second bodies 502 and 504 are in locked engagement with each other and anchoring the sheath 3 between their inner surfaces.

A row of the modules 500 can be mounted to a fiber organizer of a telecommunications closure.

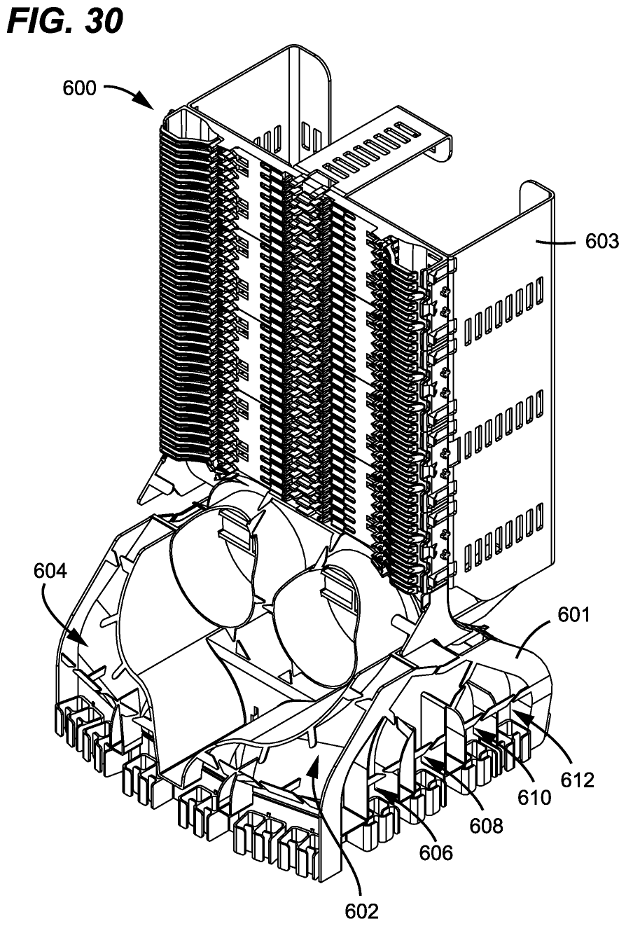

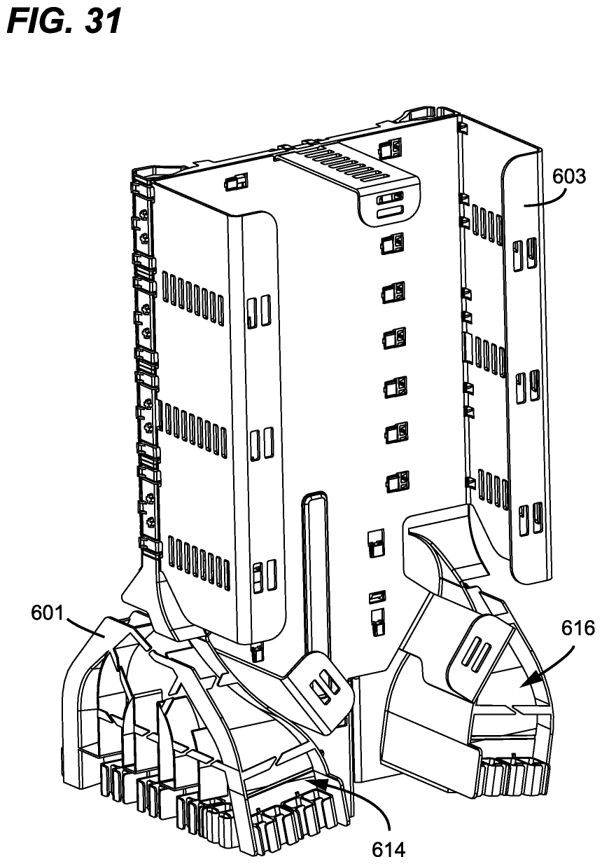

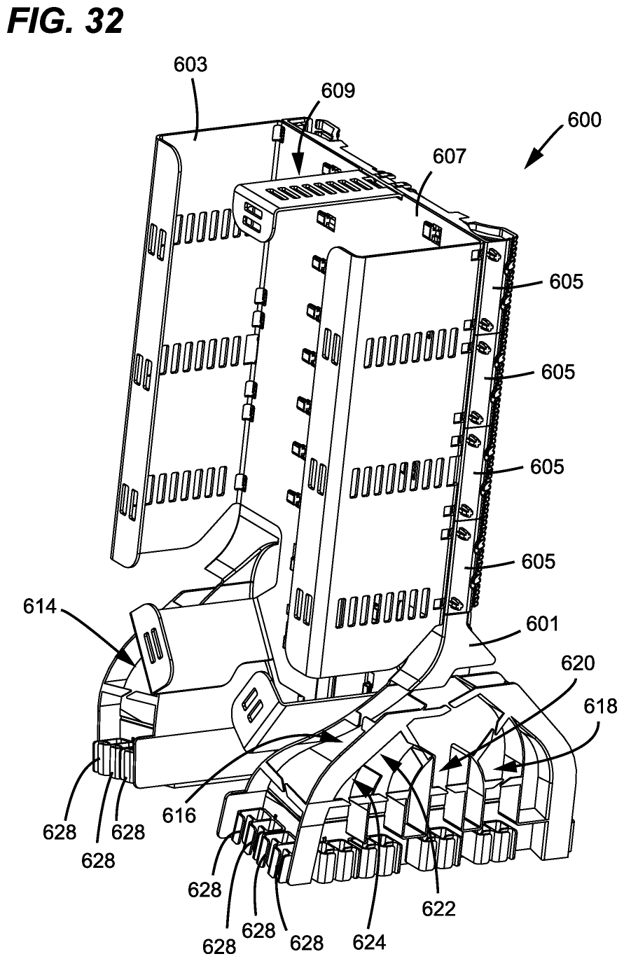

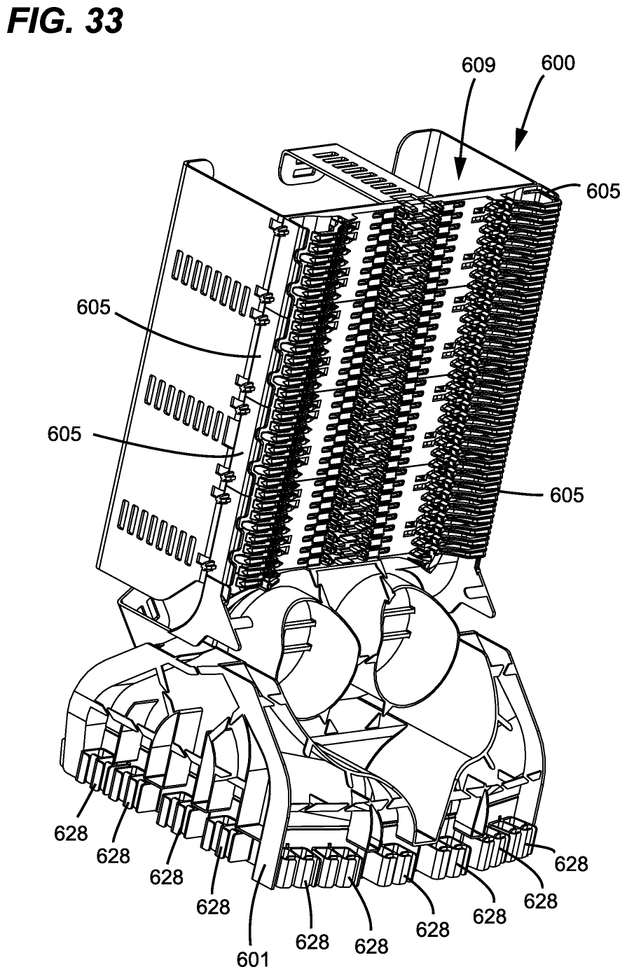

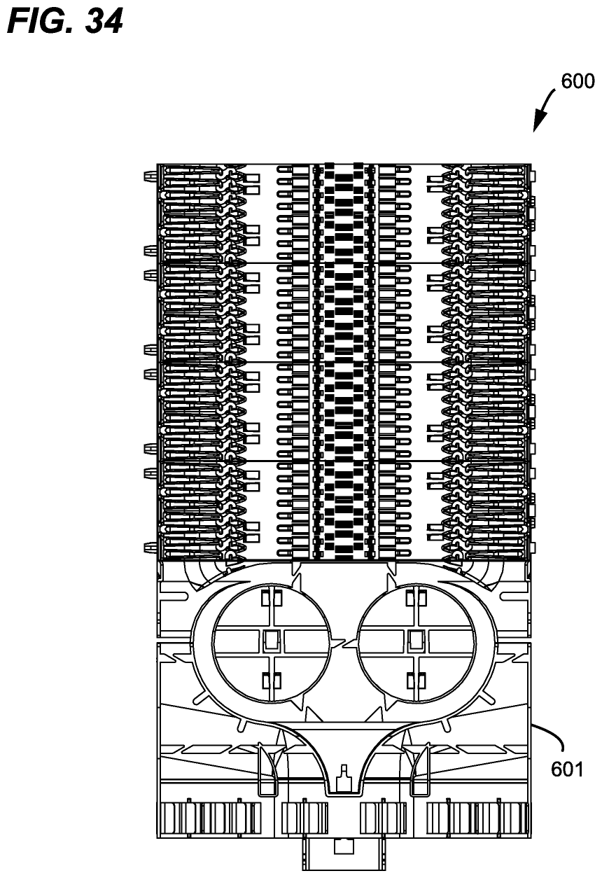

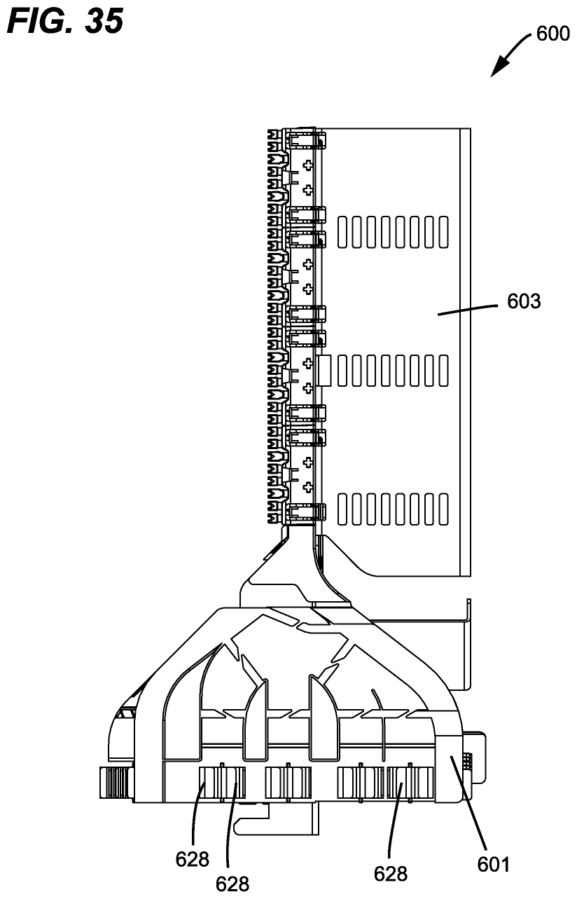

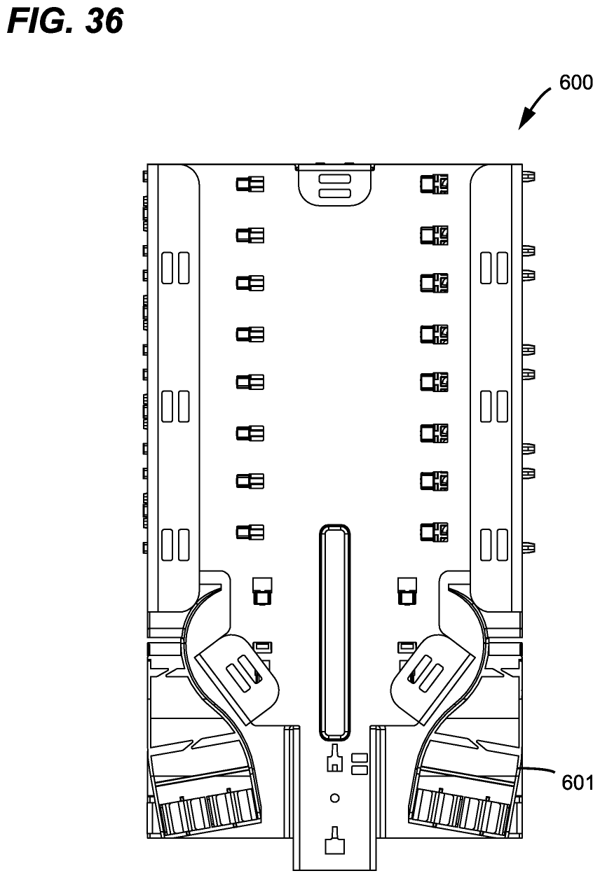

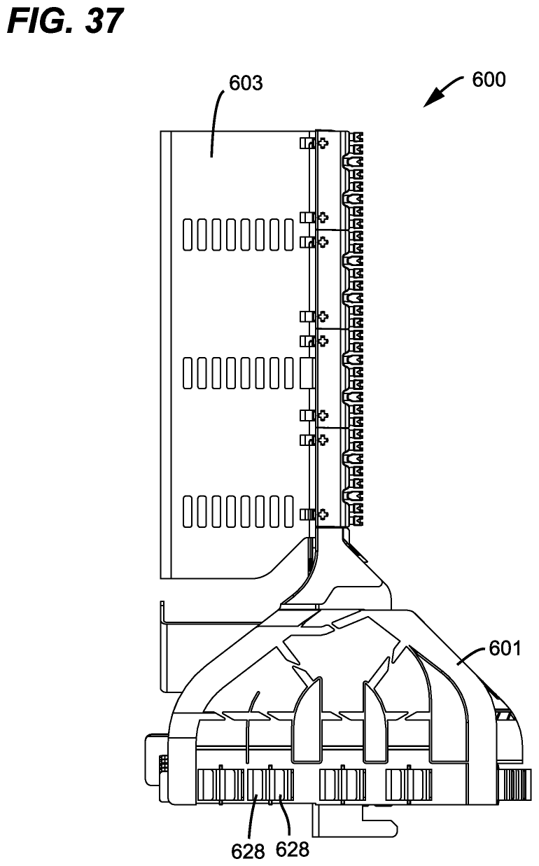

Referring to FIGS. 30-38, a further example fiber organizer 600 is shown, including a fiber manager 601. The fiber manager 601 includes structures for routing optical fibers, including walls that define various curved fiber or fiber sheath guiding and retaining channels, such as channels 602, 604, 606, 608, 610, 612, 614, 616, 618, 620, 622 and 624.

To the fiber manager is mounted a frame 603. The frame 603 can be constructed of, e.g., sheet metal. The frame includes a main plate 607 to which are mounted tray support modules 605. Fiber management trays can be pivotally mounted to the tray support modules. The main plate 607 together with other walls and flanges of the frame 603 define a basket 609 configured to store loops of sheathed fibers from cables entering the closure that are routed to fiber management trays.

Mounted to the fiber manager 601 is an arrangement of sheath holder modules. The arrangement includes rows of sheath holder bodies 628 each configured to anchor one or more sheaths of optical fibers similarly to the bodies 112 (FIG. 8) described above. The channels 602, 604, 606, 608, 610, 612, 614, 616, 618, 620, 622 and 624 are configured to guide fibers of sheaths held by the sheath holder bodies 628 toward one or both of the basket 609 and the tray support modules 605.

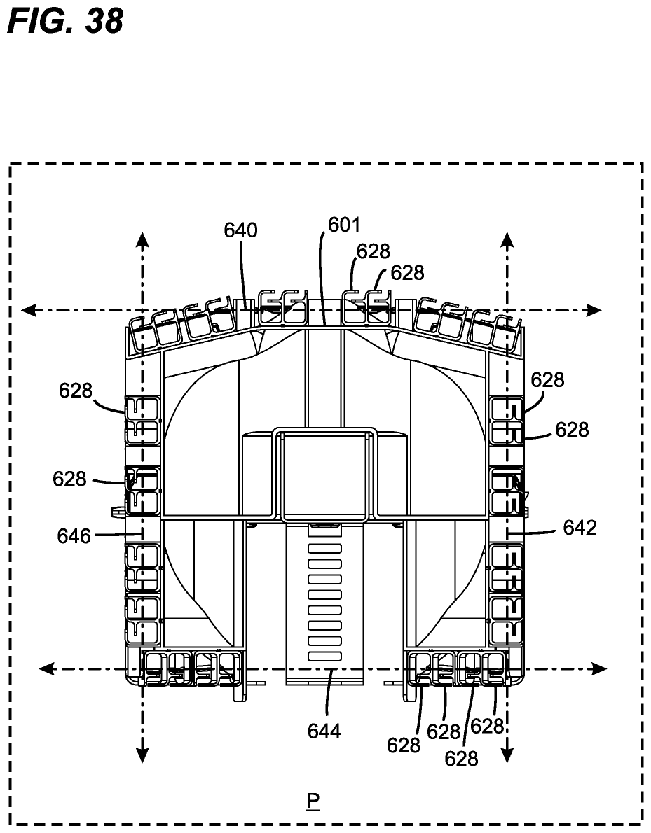

Each row of sheath holder bodies 628 defines a row axis extending through centers of the sheath holder bodies of the row. Four such axes 640, 642, 644 and 646 projected into a plane P are shown in FIG. 38, the plane P coinciding with the plane of the page. The projected axes 640 and 642 are perpendicular to each other. The projected axes 642 and 644 are perpendicular to each other. The projected axes 644 and 646 are perpendicular to each other. The projected axes 646 and 640 are perpendicular to each other. wherein the sheath holder bodies are grouped into groups, each group leading to a different guide channel defined by the fiber manager.

The illustrated arrangement of rows of sheath holder bodies thus includes rows of sheath holder bodies on each of four different and perpendicular sides of the organizer 600. This arrangement can increase the fiber management capacity of a fiber organizer. For example, the arrangement can provide for more direct routes for fibers of cables entering the closure to the fiber manager 601 such that less internal closure space is required to route fibers from cable to the fiber manager 601. In addition the arrangement can advantageously provide for an increased number of fiber access points from cables to the organizer.

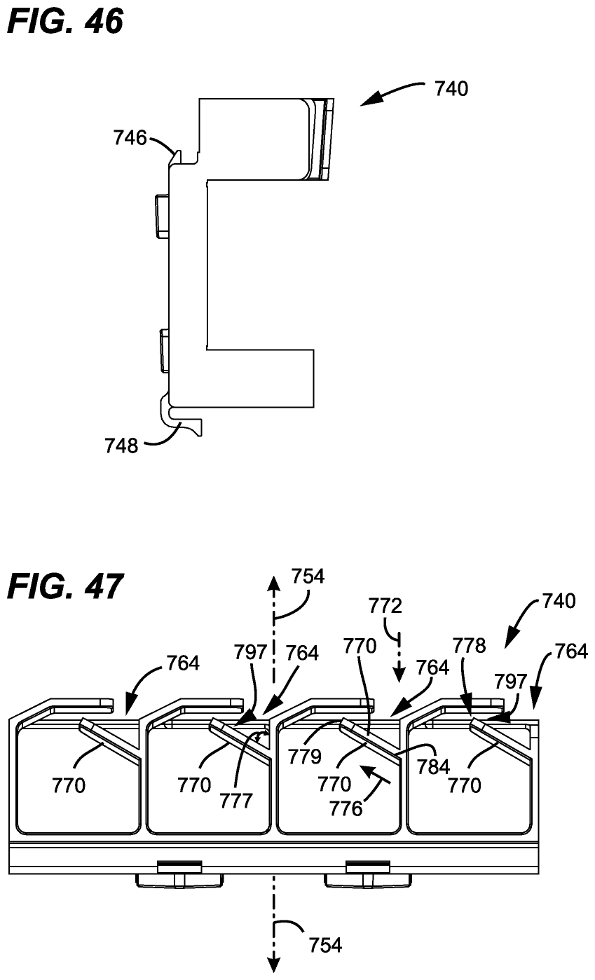

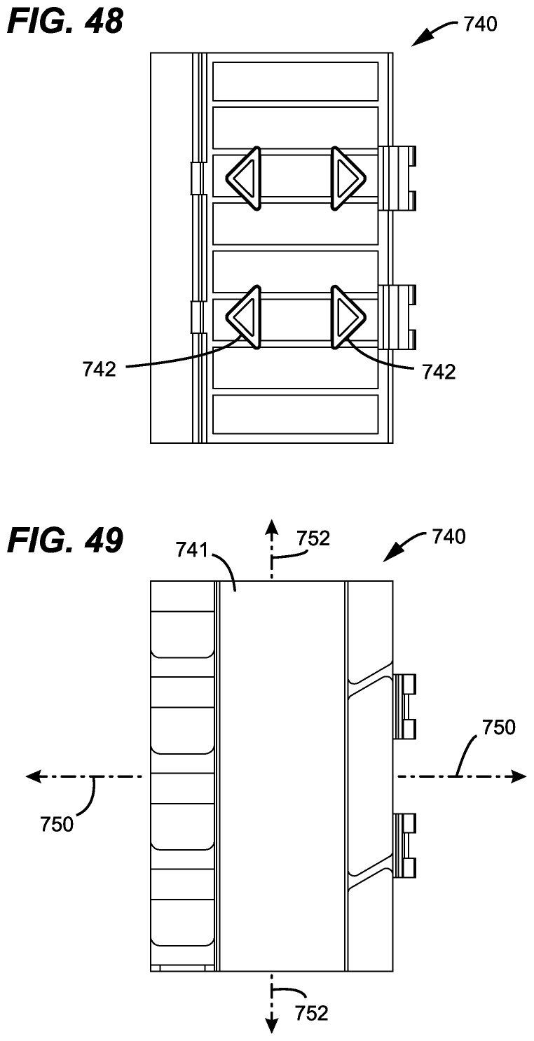

Referring now to FIGS. 39-52, a further example telecommunications closure, organizer, fiber manager, sheath holding module, and sheath holding module application will be described.

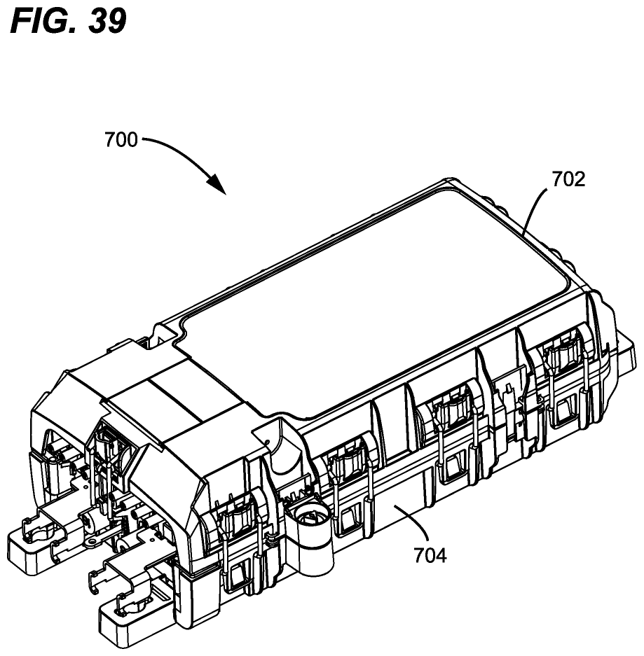

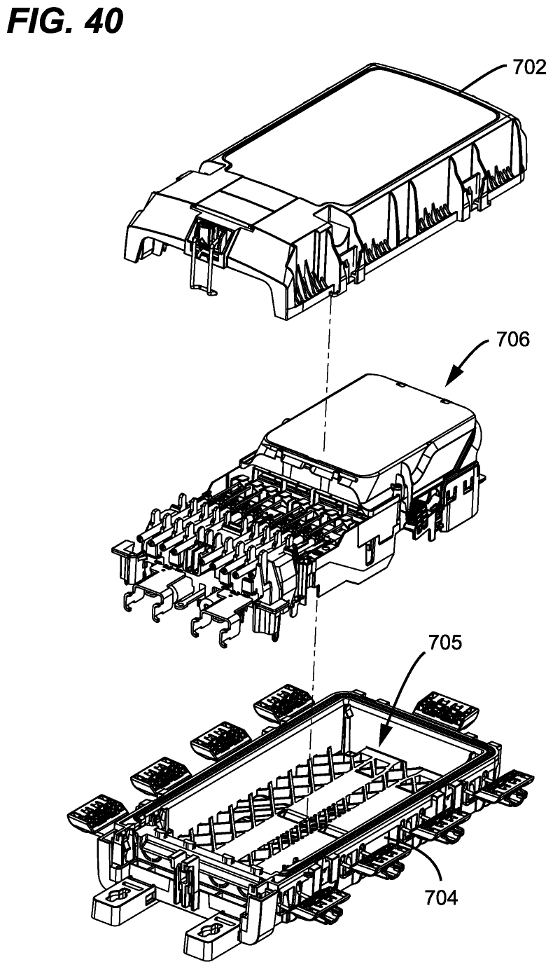

Referring to FIGS. 39 and 40, a telecommunications closure 700 includes housing pieces 702 and 704 that cooperate to define a sealable and re-enterable closure volume 705 in which can be positioned an optical fiber organizer 706.

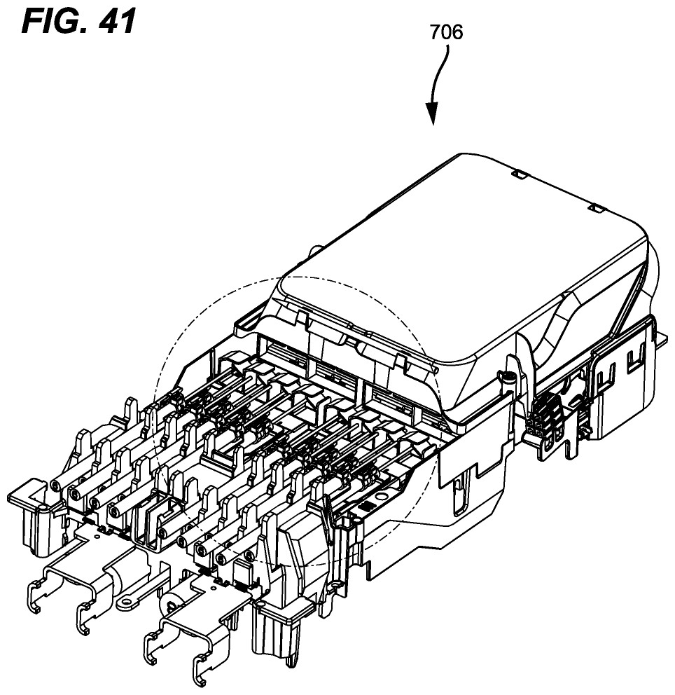

Referring to FIGS. 41-43, the organizer 706 includes a main support structure 711. Cable fixation assemblies are connectable to the main support structure 711. For example, a cable fixation assembly including a cable 712, a cable fixation body 714, tie wraps 716 for securing the jacket of the cable 712 to the fixation body 714, and a baseplate 718 defining slots 720 for lockingly receiving hook members 721 of the cable fixation body 714 that can be secured to the main support structure 711 by, e.g., locking the baseplate 718 to the main support structure 711. Each cable fixation body 714 can support one or more cables. In the example shown, each cable fixation body 714 is supporting two drop cables 712.

Optical fibers of the drop cables 712 are spliced or otherwise made optically continuous with optical fibers of one or more feeder cables, such as the feeder cable 720 that is also entering the closure and is affixed to the main support structure 711 on the side of the main support structure 711 that is opposite the side on which the baseplate 718 is affixed. For example, the optical fibers of the drop cables 712 can be spliced to the optical fibers of the feeder cable 720 at splices held on fiber management trays 722.

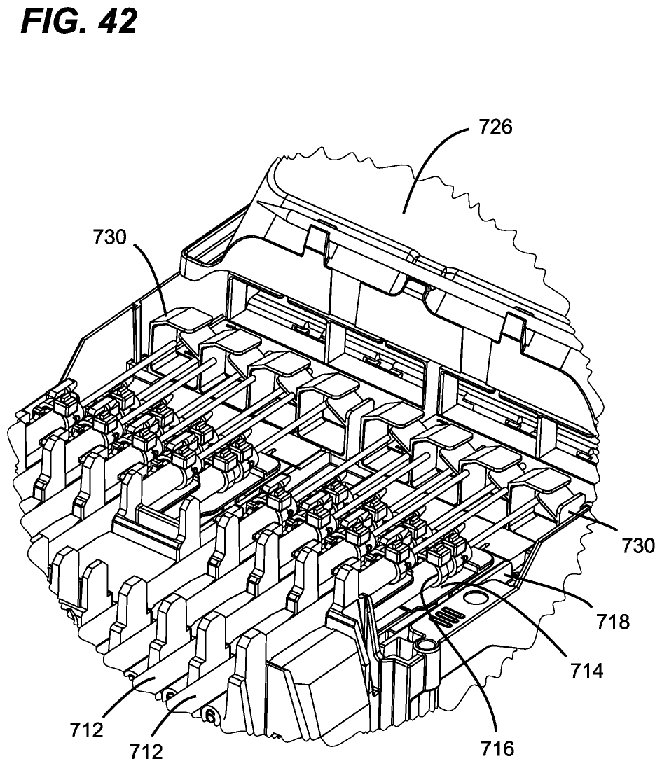

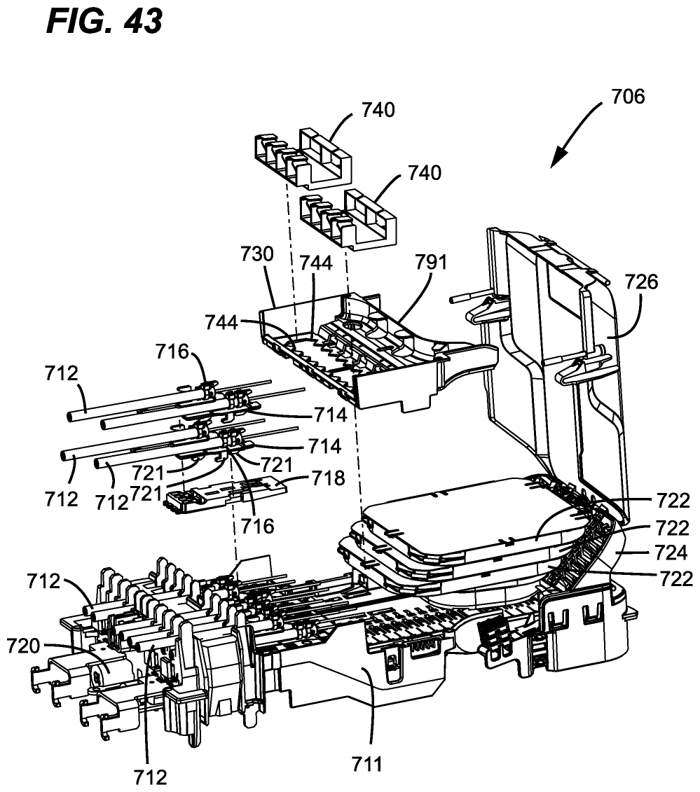

The fiber management trays 722 are pivotally mounted to a tray support structure 724. A demarcation cover 726 is coupled to the main support structure 711 and selectively covers the trays 722. The demarcation cover 726 can be pivoted open (as shown in FIG. 43) to access the trays 722 or kept closed (as shown in FIG. 41) to prevent access to the trays 722 or otherwise protect the trays 722 while work is being done on other parts of the organizer 706. The trays 722, tray support structure 724, and demarcation cover 726 form part of the organizer 706.

The organizer 706 includes a fiber manager 730. The fiber manager 730 is differently configured from other fiber managers disclosed herein.

In some implementations, the fiber manager 730 can mount one or more banks of fiber optic adapters. Such adapters can be used to optically connect connectorized drop cables. For example, the fibers from the cables 712 and the cable 720 could be connectorized and, rather than requiring a splice, a fiber of a cable 712 and a fiber of a cable 720 can be optically connected by connecting their respective connectors together at an adapted supported by the fiber manager 730.

In another example implementation, the fiber manager 730 can support adapters, or non-functional receptacles that behave like one-sided adapters, which can serve as parking or storage for connectors of optical fibers entering the closure until an active fiber optic connection is needed.

In the implementation shown, fibers of the drop cables 712 and fibers of the feeder cable 720 are not connectorized. As a result, the fibers of the drop cables need to be routed in an organized way to the trays 722.

The fiber manager 730 can also be used in a manner that combines two or three of the implementations just described. For example, a portion of the fiber manager 730 can support fiber optic adapters that connect connectorized optical fibers of drop cables and feeder cables, and another portion of the fiber manager 730 can support a module that guides fibers in an organized way to the trays 722. Other combinations of the various implementations can also be accommodated by the fiber manager 730.

To route fibers to the trays 722, the fiber manager 730 can support one or more sheath holder modules 740. In the example shown, the fiber manager 730 is supporting two of the modules 740. The two modules 740 receive all of the fibers from the drop cables 712 that are routed to the trays 722.

In the example shown, a portion of each module 740 can be advantageously covered by the demarcation cover 726. Covering this portion of the module 740 can protect loose fibers extending beyond the axial ends of their sheaths, with the sheaths terminating a sheath termination zone defined by the module 740, as described in more detail below (FIG. 52).

Each module 740 includes a body 741. A mounting interface is provided between the module 740 and the fiber manager 730. The interface includes one or a plurality of mating shapes which interlock with one another to form a mating interface, such as the mating shapes 742 and 744. The interlocking shapes or structures 742 and 744 provide engageable surfaces or shoulders which engage one another in at least one direction parallel to an axial direction of a cable 712 or cables 712 attached to the main support structure 711. In one example shown, the interlocking shapes include one or a plurality of V-shapes and a reciprocal surface for receiving the one or the plurality of the V-shapes. The interlocking shapes can include mating protrusions and recesses. Two oppositely facing V-shapes are provided for mating along an axial or parallel direction of the cable in two opposite directions along the cable axis.

The mounting interface also includes flexible tabs 748 of the module 740 which interlock with mating shoulders defined by the fiber manager 730. The mounting interface also includes clips 746 of the module 740 which interlock with one or a plurality of mating slots of the fiber manager 730.

The mounting interface can be configured such that axial load applied to a cable 712 from which sheathed fibers are routed through the module 740 is applied to the mounting interface, including the interlocking shapes. In addition, V-shapes also can perform a centering function for the module 740 mounting the fiber manager 730, so as to maintain the axial positions (parallel to the longitudinal axes of the cables 712) they are located in.

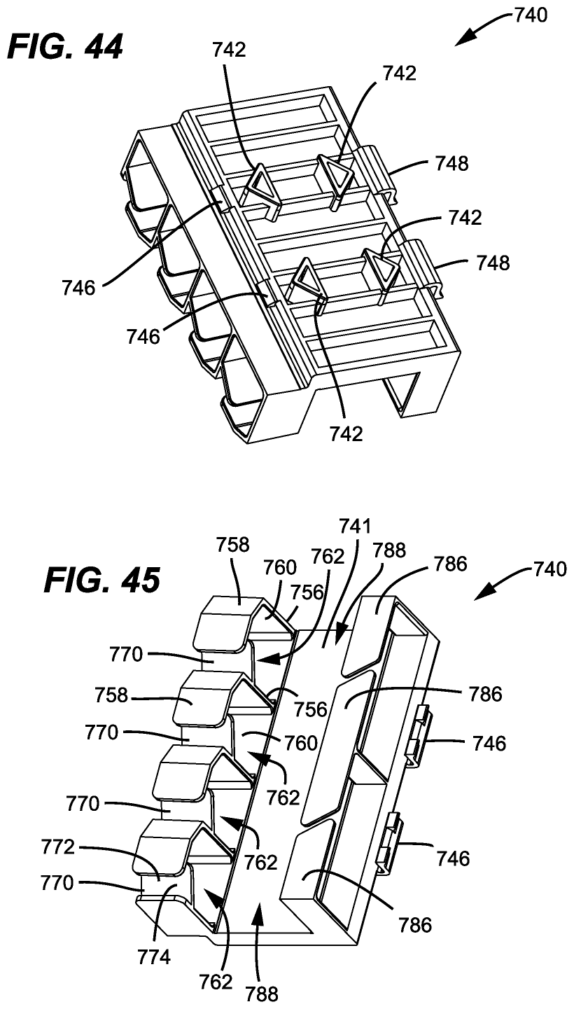

Referring to FIGS. 44-52, the sheath holder module 740 will be further described. The sheath holder module 740 is configured to anchor one or more sheaths 780 of optical fibers 781. The module 740 includes a body 741. The body 741 defines a first axis 750, a second axis 752, and a third axis 754 that are mutually perpendicular to one another. The axis 750 is generally parallel to the longitudinal axes of the cables 712.

The body 741 includes walls 756 each having an outer surface 758 and an inner surface 760 facing away from the outer surface 758.

Each inner surface 760 defines a sheath holding volume 762 configured to hold one or more sheaths 780 having an elongate dimension substantially parallel to the first axis 750. The walls 756 are configured to at least substantially surround sheaths anchored in the sheath holding volumes 762. For example, referring to FIG. 52, the sheath holding volume 762A is holding two sheaths 780, each sheath 780 having a longitudinal dimension at least substantially parallel to the first axis 750 and a round, hollow cross-section perpendicular to the longitudinal dimension that defines the sheath's transverse diameter.

In some examples, sheaths of multiple sizes can be anchored in the same sheath holding volume 762. In addition, different sheath holding volumes of the same module 740 can accommodate different sized sheaths from one another.

For each module 740, the walls 756 define four sheath holding volumes 762. Alternatively, a module body can define more or fewer sheath holding volumes.

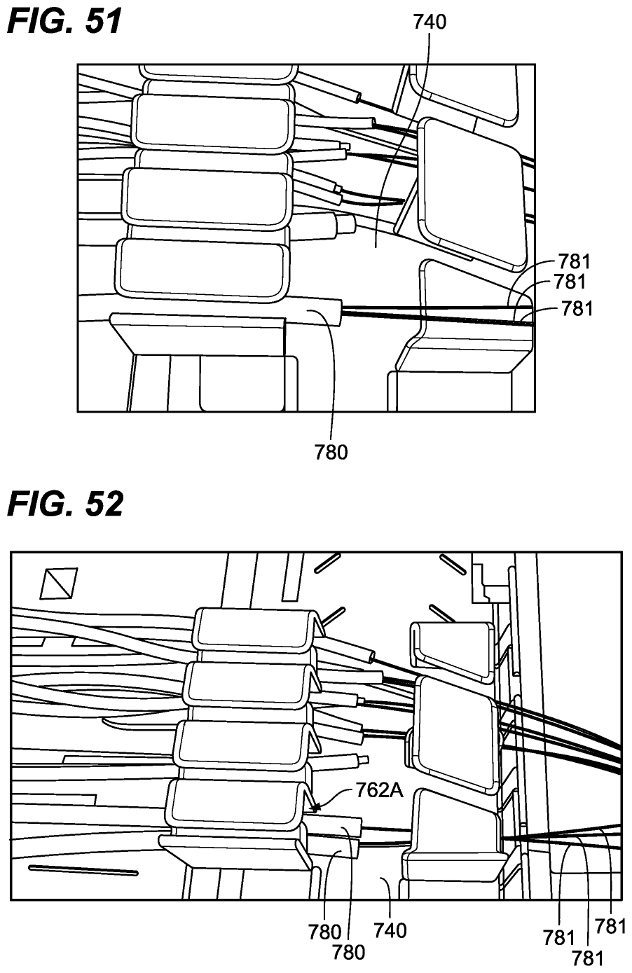

The walls 756 of the body 741 define, for each sheath holding volume 762, a slot 764 that is in communication with the corresponding sheath holding volume 762. Each slot 764 is elongate parallel to the first axis 750 and is configured to allow a sheath to be inserted into the corresponding sheath holding volume 762 in a direction 772 that is perpendicular to the first axis 750 (FIG. 51).

Thus, the module 740 advantageously provides for lateral loading of sheaths into sheath holders mounted to a fiber manager 730, rather than pass-through axial loading of sheaths into the sheath holders the latter of which can be cumbersome, or even impossible without cutting the sheaths and the fibers.

A largest width dimension W6 of each slot 764 perpendicular to the elongate dimension is smaller (e.g., by a factor of two, three, four or greater) than a largest width dimension parallel to at least one of the axes 750, 752, 754 of the corresponding sheath holding volume 762. Thus, each slot 764 defines a relatively tight lateral entryway for a sheath into the corresponding sheath holding volume, which can provide for improved retention of a sheath within the sheath holding volume 762, e.g., by minimizing unwanted passage of a sheath from the sheath holding volume through the slot 764, while also providing a sheath holding volume 762 that can anchor multiple sheaths, e.g., at least two, at least four, at least six, at least eight, or more sheaths of the same or different transverse diameters.

In some examples, the body 741 is constructed of a flexibly resilient material such that the slot 764 expands as a sheath passes through the slot and resiliently returns to its rest size (e.g., shrinks) when the sheath has passed through the slot 764. Sizing the slot 764 relative to a sheath in this manner can further improve retention of the sheath within the sheath holding volume 762.

The module 740 provides another feature that improves retention of the sheaths within the sheath holding volumes 762, e.g., without requiring covers. Covers are additional parts that can increase the cost of manufacture and increase the complexity of sheath installation and retention, requiring a technician to install the covers after inserting the sheaths in the sheath holders.

Specifically, the walls 756 of the module 740 advantageously include sheath retention tabs 770. Each tab 770 extends from a fixed end 784 to a free end 779, along a direction parallel to the direction of the arrow 776 that is oblique to both the axes 752 and 754. The sheath retention tab 770 is sized and positioned such that installing a sheath into the sheath holding volume 762 requires at least two motions of the sheath in different directions. A first motion is through the slot 764, which motion can be parallel to the direction 772, which is perpendicular to the major surface 774 of the tab 770. A second motion is generally parallel to the surface 774, which is parallel to the direction of the arrow 776, until the sheath clears the tab 770 at the space 778 defined between an inner surface 760 of a wall 756 and the free end 779 of the tab 770. The tab 770 can be configured to flex about its fixed end 784 to allow the sheath to pass through the space 778, and then return to its unflexed position after the sheath has been installed in the sheath holding volume 762 to help retain the sheath therein.

For further improved retention of sheaths in the sheath holding volumes 762, the directions of the arrows 772 and 776 are separated by an acute angle 777. In some examples, the directions of the arrows 772 and 776 span an angle 777 of between about 10 degrees and about 80 degrees. In some examples, the directions of the arrows 772 and 776 span an angle 777 of between about 20 degrees and about 70 degrees.

The walls 756, including the tabs 770, define labyrinthine sheath passages 797.

Thus, the tabs 770 can allow the sheaths to self-retain in the sheath holding volumes 762 without additional retention components.

Each sheath holder module 740 includes fiber retention lips 786 and a sheath termination zone 788. The sheath termination zone 788 is positioned between the sheath holding volumes 762 and the fiber retention lips 786 along the axis 750. Thus, the sheath holding volumes 762 and the fiber retention lips 786 are spaced apart from each other along the axis 750.

In the example shown, the module 740 is of unitary molded construction, including the walls 756, the tabs 770, the lips 786 and the defined sheath termination zone 788.

Sheaths 780 end in the termination zone 788 and the optical fibers 781 continue on. For example, the sheaths 780 are stripped to axially end in the zone 788, and the fibers 781 continue from the axial ends of the sheaths 780 along a routing path that exit the fiber manager 730 and continue on toward the trays 722. The lips 786 are positioned to retain the fibers 781 on the desired routing paths as they leave the sheaths 780 in the zone 788.

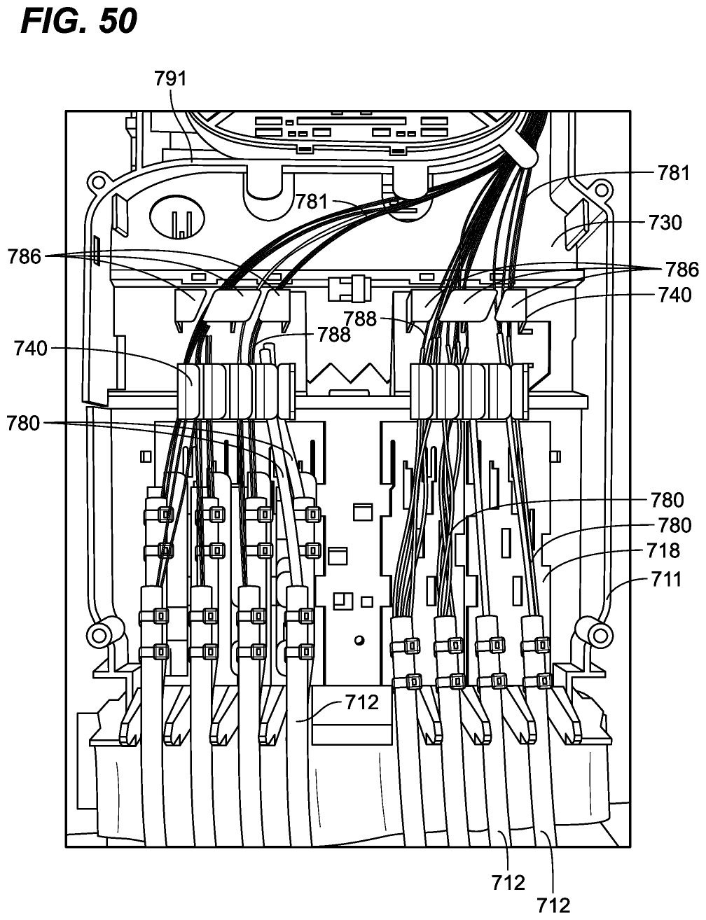

Sheaths can expand or grow under different circumstances, such as changes in temperatures or exposure to external loads. If a sheath grows, the routing path of the fibers extending from the end of the sheath can be impacted, because sheaths, for example, do not bend as readily as optical fibers. Thus, for example, the loose fibers can be caused to over-bend, which can result in fiber breakage or signal loss. Referring to FIG. 50, if the sheaths 780 were to grow parallel to the longitudinal axes of the cables 50, the bend radii of the loose fibers 781 would decrease as the fibers would become sandwiched, or crushed, between the ends of the sheath 780 and the wall 791 of the fiber manager 730.

Each of: (i) the fiber manager 730; (ii) the modules 740 with the built in termination zone 788 and built in spacing between the sheath holding volumes 762 and fiber retention lips 786; and (iii) the mounted positions of the modules 740 on the fiber manager 730 relative to the wall 791, are configured to provide enough space for the loose fibers 781 to bend further, without over-bending, on their routing paths on the fiber manager 730 in response to typical or even extreme longitudinal growth of the sheaths 780.

For example, the sheath holder module 740 is configured itself, and also positioned relative to the fiber manager 730 such that any axial growth of a sheath 780 containing an optical fiber 781 and held in a sheath holding volume 762 that causes an axial end of the sheath 780 to advance within, but not beyond, the sheath termination zone 788 (or not beyond the module 740) cannot cause the optical fiber 781 to bend beyond a minimum bend radius of that optical fiber 781 within the fiber manager 730.

From the foregoing detailed description, it will be evident that modifications and variations can be made in the devices and methods of the disclosure without departing from the spirit or scope of the invention.

What is claimed is:

1. A sheath holder module for anchoring one or more sheaths of optical fibers at a fiber organizer of a telecommunications closure, comprising:
a body, defining:
a first axis, a second axis, and a third axis that are mutually perpendicular to one another;
an outer surface;
an inner surface facing away from the outer surface, the inner surface defining a sheath holding volume configured to hold one or more sheaths having an elongate dimension substantially parallel to the first axis; and
a slot in communication with the sheath holding volume, the slot being elongate parallel to the first axis and configured to allow a sheath to be inserted into the sheath holding volume in a direction perpendicular to the first axis, a largest width dimension of the slot perpendicular to the elongate dimension being smaller than a parallel largest width dimension of the sheath holding volume.

2. The sheath holder module of claim 1, comprising a plurality of the body interconnected to one another and aligned parallel to the second axis.

3. The sheath holder module of any of claims 1-2, wherein the body includes couplers for releasably attaching the sheath holder module to a fiber manager of a fiber organizer of a telecommunications closure.

4. The sheath holder module of any of claims 1-3, further comprising a cover to at least partially close the slot.

5. The sheath holder module of claim 4, wherein the cover includes a cap configured to lockingly attach to the body.

6. The sheath holder module of claim 4, wherein the cover includes an elastomeric insert configured to engage the body by frictional fit.

7. The sheath holder module of any of claims 1-6, wherein the body comprises a flexibly resilient material such that the slot expands as a sheath passes through the slot and shrinks when the sheath has passed through the slot.

8. The sheath holder module of any of claims 1-7, wherein the sheath holding volume defines a labyrinthine sheath passage in a plane perpendicular to the first axis.

9. The sheath holder module of claim 8, wherein the body defines a plurality of ribs projecting perpendicularly to the first axis partially defining the labyrinthine sheath passage perpendicularly.

10. The sheath holder module of any of claims 1-7, wherein the body includes a plurality of ribs projecting perpendicularly to the first axis and partially defining the sheath holding volume.

11. The sheath holder module of any of claim 9 or 10, wherein the ribs define discrete anchoring positions for sheaths within the sheath holding volume.

12. A sheath holder module for anchoring one or more sheaths of optical fibers at a fiber organizer of a telecommunications closure, comprising:
a body, defining:
a first axis, a second axis, and a third axis that are mutually perpendicular to one another;
an outer surface; and
a wall defining a labyrinthine sheath passage in a plane perpendicular to the first axis.

13. The sheath holder module of claim 12, wherein the labyrinthine sheath passage is configured to hold a plurality of sheaths having an elongate dimension substantially parallel to the first axis.

14. The sheath holder module of claim 12, further comprising a slot elongate parallel to the first axis and configured to allow a sheath to be inserted into the sheath passage in a direction perpendicular to the first axis.

15. The sheath holder module of any of claims 12-14, comprising a plurality of the body interconnected to one another and aligned parallel to the second axis.

16. The sheath holder module of any of claims 12-15, wherein the body includes couplers for releasably attaching the sheath holder module to a fiber manager of a fiber organizer of a telecommunications closure.

17. The sheath holder module of claim 12, wherein the cover includes an elastomeric insert configured to engage the body by frictional fit.

18. The sheath holder module of any of claims 12-17, wherein the body comprises a flexibly resilient material such that the slot expands as a sheath passes through the slot and shrinks when the sheath has passed through the slot.

19. The sheath holder module of any of claims 12-18, wherein the body includes a plurality of ribs projecting from the wall into the labyrinthine sheath passage perpendicularly to the first axis.

20. The sheath holder module of claim 1, wherein the ribs define discrete anchoring positions for sheaths.

21. A sheath holder module for anchoring one or more sheaths of optical fibers at a fiber organizer of a telecommunications closure, comprising:
a first body including an inner surface and an outer surface; and
a second body including an inner surface and an outer surface, the first and second bodies cooperating to define a sheath holding volume configured to hold one or more sheaths, the first and second bodies configured to twistingly cooperate at an interface between the inner surfaces of the first and second bodies to anchor one or more sheaths between the inner surfaces of the first and second bodies within the sheath holding volume.

22. The sheath holder module of claim 21, wherein the first and second bodies are configured to cooperate to secure sheaths of different transverse dimensions.

23. The sheath holder module of any of claims 21-22, wherein the interface includes interlocking structures on the first and second bodies that releasably lock to each other when one of the first and second bodies is twisted relative to the other of the first and second bodies by a predetermined rotation magnitude.

24. The sheath holder module of claim 23, wherein the interface includes a twist stop that prevents twisting beyond the predetermined rotation magnitude.

25. The sheath holder module of any of claims 1-24, further comprising a sheath holding a plurality of optical fibers anchored within the sheath holding volume or the labyrinthine sheath passage.

26. The sheath holder module of any of claims 1-24, further comprising a plurality of sheaths each holding a plurality of optical fibers and anchored within the sheath holding volume or the labyrinthine sheath passage.

27. A fiber optic organizer for a telecommunications closure, comprising:
a main assembly defining a longitudinal axis of the main assembly, the main assembly supporting:
a fiber manager;
a plurality of fiber management trays; and
a sheath holder module according to any of claims 1-26.

28. The fiber optic organizer of claim 27, comprising a plurality of the sheath holder module supported by the main assembly, the first axes of the sheath holder modules forming oblique angles with the longitudinal axis of the main assembly.

29. The fiber optic organizer of claim 27, comprising first and second of the sheath holder modules supported by the main assembly, the first axes of the first sheath holder modules being non-parallel to the first axes of the second sheath holder modules.

30. A fiber optic closure, comprising:
housing pieces that cooperate to define a sealable and re-enterable closure volume; and
a fiber optic organizer according to any of claims 27-29 positioned within the closure volume.

31. A fiber organizer for a fiber optic closure, comprising:
a fiber manager including structures for routing optical fibers, the fiber manager being configured to mount a frame that can mount a tray support module for pivotally mounting fiber management trays, the fiber manager being further configured to mount sheath holder modules in an arrangement, the arrangement defining at least three rows of sheath holder bodies each configured to anchor one or more sheaths of the optical fibers, wherein each row defines a row axis extending through centers of the sheath holder bodies of the row, the row axis of one of the rows projected in a reference plane being perpendicular to the row axis of each of the other two rows projected in the reference plane.

32. The fiber organizer of claim 31, wherein the arrangement includes a fourth row of sheath holder bodies, the fourth row defining a fourth row axis extending through centers of the sheath holder bodies of the fourth row, wherein each row axis projected in the reference plane is perpendicular to two others of the row axes projected in the reference plane.

33. The fiber organizer of any of claims 31-32, wherein each sheath holder body defines:
a first axis, a second axis coinciding with a corresponding one of the row axes, and a third axis, the first, second and third axes being mutually perpendicular to one another;
an outer surface; and
a wall defining a labyrinthine sheath passage in a plane perpendicular to the first axis.

34. The fiber organizer of any of claim 31-33, wherein the sheath holder bodies are grouped into groups, each group leading to a different guide channel defined by the fiber manager.

35. The fiber organizer of claim 34, further comprising the frame mounted to the fiber manager and the tray support module mounted to the frame at a front side of the frame, the frame defining a basket for storing loops of sheathed fibers at a back side of the frame, wherein the channels are configured to guide fibers of sheaths held by the sheath holder bodies toward one or both of the basket and the tray support module.

36. The module of claim 1, wherein the body defines a sheath retention tab projecting from a fixed end at the inner surface to a free end along a direction that is perpendicular to the first axis, and oblique to each of the second axis and the third axis.

37. The module of claim 12, wherein the wall includes a sheath retention tab projecting from a fixed end to a free end along a direction that is perpendicular to the first axis, and oblique to each of the second axis and the third axis, the sheath retention tab partially defining the labyrinthine sheath passage.

38. A sheath holder module for anchoring one or more sheaths of optical fibers at a fiber organizer of a telecommunications closure, comprising:
a body defining a first axis, a second axis, and a third axis that are mutually perpendicular to one another, the body including a wall having:
an outer surface; and
an inner surface facing away from the outer surface, the inner surface defining a sheath holding volume configured to hold one or more sheaths having an elongate dimension substantially parallel to the first axis,
wherein the wall defines a slot in communication with the sheath holding volume, the slot being elongate parallel to the first axis and configured to allow a sheath to be inserted into the sheath holding volume in a direction perpendicular to the first axis; and
wherein the body includes a sheath retention tab projecting from a fixed end at the inner surface to a free end along a direction that is perpendicular to the first axis, and oblique to each of the second axis and the third axis.

39. The module of claim 38, further comprising a sheath that is self-retained in the sheath holding volume without a cover for the slot.

40. The module of any of claims 38-39, wherein the sheath retention tab is configured to flex about the fixed end when a sheath is passed through a space between the inner surface and the free end of the tab.

41. The module of claim 40, wherein the sheath retention tab is configured to resiliently return to an unflexed configuration once the sheath has passed through the space.

42. The module of any of claims 38-41, wherein the body is of unitary molded construction, the body including fiber retention lips spaced apart from the wall along the first axis, the body further defining a sheath termination zone between the wall and the fiber retention lips along the first axis.

43. A method, comprising:
providing the module as in claim 42;
inserting a sheath through the slot of the module and into the sheath holding volume; and
stripping the sheath such that an end of the sheath is positioned in the sheath termination zone.

44. The method of claim 43, further comprising positioning the fibers to be retained by the fiber retention lips.

45. A fiber optic organizer for a telecommunications closure, comprising:
a fiber manager; and
a sheath holder module having a body including a wall defining a sheath holder volume and a fiber retention lip, the sheath holder module defining a sheath termination zone between the sheath holder volume and the fiber retention lip, the sheath holder module being connected to the fiber manager and positioned relative to the fiber manager such that any axial growth of a sheath containing an optical fiber and held in the sheath holding volume that causes an axial end of the sheath to advance within, but not beyond, the sheath termination zone cannot cause the optical fiber to bend beyond a minimum bend radius of the optical fiber within the fiber manager.

46. The organizer of claim 45, further comprising:
a main support structure, the fiber manager being mounted to the main support structure;
fiber management trays pivotally mounted relative to the main support structure; and
a demarcation cover coupled to the main support structure and configured to cover the trays and at least the fiber retention lip of the sheath holder module.

47. A method, comprising:
providing a fiber manager;
providing a sheath holder module having a body including a wall defining a sheath holder volume, the sheath holder module defining a sheath termination zone;
connecting the sheath holder module to the fiber manager at a location on the fiber manager;
fixing a cable jacket of a cable containing an optical fiber relative to the fiber manager;
laterally inserting a sheath containing the optical fiber into the sheath holder volume; and
stripping the sheath such that an axial end of the sheath is positioned in the sheath termination zone and such that the optical fiber continues from the sheath beyond the sheath holder module within the fiber manager.

48. The method of claim 47,
wherein the sheath holder module includes a fiber retention lip, the sheath termination zone being positioned between the wall and the fiber retention lip, the method further comprising:
feeding the fiber under the fiber retention lip.

49. The method of any of claims 47-48, further comprising:
determining the location such that any axial growth of the sheath that causes an axial end of the sheath to advance within, but not beyond, the sheath termination zone cannot cause the optical fiber to bend beyond a minimum bend radius of the optical fiber within the fiber manager.

50. The method of claim 49, wherein the determining is based on a predefined minimum bend radius of the optical fiber.

51. A method, comprising:
providing a sheath containing an optical fiber, the sheath defining a longitudinal axis;
inserting the sheath into a sheath holding volume defined by a sheath holder module, the inserting including:
a first motion of the sheath, followed by;
a second motion of the sheath, the first motion being a motion along a first direction that is substantially perpendicular to the axis and through a slot defined by the module, the second motion being along a second direction that is substantially perpendicular to the axis and through a space defined by the module, wherein the first direction and the second direction define an acute angle therebetween.

52. A method, comprising:
providing a sheath containing an optical fiber, the sheath defining a longitudinal axis;
inserting the sheath into a sheath holding volume defined by a sheath holder module, the inserting including:
a first motion of the sheath, followed by;
a second motion of the sheath, the first motion being a motion along a first direction that is substantially perpendicular to the axis and through a slot defined by the module, the second motion being along a second direction that is substantially perpendicular to the axis, wherein the first direction and the second direction are substantially perpendicular to each other.
